(19) United States
(12) Patent Application Publication
(10) Pub. No.: US 2026/0094084 A1
(43) Pub. Date: Apr. 2, 2026

(54) SYSTEMS AND METHODS FOR ROTATION MANAGEMENT

(71) Applicant: Atlassian US, Inc., San Francisco, CA (US)

(72) Inventors: Batuhan Kama, Ankara (TR); Berat Gümüs, Izmir (TR); Berke Tezergil, Ankara (TR); Fatma Sirin Koru, Ankara (TR)

(21) Appl. No.: 18/902,371

(22) Filed: Sep. 30, 2024

(51) Int. Cl. G06Q 10/0631; G06F 9/451

(52) U.S. Cl. CPC G06Q 10/063116; G06F 9/451

(57) ABSTRACT

Systems and methods provide techniques for improving computational efficiency of rotation updates and storage. In various embodiments, a method includes obtaining from a rotation table a plurality of versions of a rotation for performing a task in accordance with a task schedule, wherein: the plurality of versions comprises at least one historical version of the rotation and a current version of the rotation; in response to detecting at least one modification to the rotation, updating the current version of the rotation to generate an updated version of the rotation; enabling write access for the rotation table in response to the updated version of the rotation; and writing the updated version of the rotation to the rotation table, the updated version of the rotation being written as an additional entry to the plurality of versions of the rotation.

### BACKGROUND

Various methods, apparatuses, and systems are configured to provide techniques for efficiently managing changes to task schedules. Applicant has identified many deficiencies and problems associated with existing methods, apparatuses, and systems for efficiently updating task schedules, generating schedule notifications, and generating schedule timelines. Through applied effort, ingenuity, and innovation, these identified deficiencies and problems have been solved by developing solutions that are in accordance with the embodiments of the present disclosure, many examples of which are described in detail herein.

### BRIEF SUMMARY

In general, embodiments of the present disclosure provide methods, apparatuses, systems, computing devices, and/or the like that are configured to update versions of on-call rotations, generate schedule timelines, and determine and remove obsolete schedule notifications. For example, certain embodiments of the present disclosure provide methods, apparatuses, systems, computing devices, and/or the like that conditionally persist versions of schedules or rotations by determining whether a change has occurred to the associated schedule or rotation. In doing so, the methods, apparatuses, systems, computing devices, and/or the like may improve computational efficiency of schedule management by optimizing the frequency with which data is called from and written to databases. As an example, existing approaches may store schedule timeline periods at database periodically. However, such approaches may contribute to excessive database operations in scenarios where the period is configured to a high frequency, such as semi-hourly or hourly. In such instances, the existing approaches may apply excessive input and output operations to the database (e.g., data fetching and data writing), and many of the operations may be redundant due to there being no changes to the data between operations. The embodiments described herein mitigate such inefficiencies by limiting database interactions to instances in which there exists one or more changes to the data being written to or obtained from the database.

As another example, certain embodiments of the present disclosure provide methods, apparatuses, systems, computing devices, and/or the like that offload notification validation processes to off-peak periods and filter notification data in substantially real-time to reduce computational workloads for provisioning schedule notifications in accordance with configured time settings. Typical approaches may perform schedule validation as an operation that immediately proceeds schedule notification generation. However, such approaches may result in excess input/output requests to and from notification databases in instances of peak event activity, such as work shift changes where many on-call events may occur simultaneously. In such instances, existing approaches may be required to perform high numbers of input/output requests to validate schedule notification requests prior, which may result in throttle events and, resultingly, delays to schedule notification generation and publishing. To overcome these technical challenges, and others, the embodiments described herein perform dynamic event filtering by evaluating obsolescence of schedule notifications in response to detecting modification of rotations, overrides, task intervals, user data, and/or the like. For example, in response to detecting modification of a rotation, the methods, apparatuses, systems, computing devices, and/or the like may filter determine and discard a subset of on-call event notifications that are rendered invalid based at least in part on the modification.

In accordance with one aspect, a method is provided. In one embodiment, the method comprises obtaining from a rotation table a plurality of versions of a rotation for performing a task in accordance with a task schedule, wherein: the plurality of versions comprises at least one historical version of the rotation and a current version of the rotation; in response to detecting at least one modification to the rotation, updating the current version of the rotation to generate an updated version of the rotation; enabling write access for the rotation table in response to the updated version of the rotation; writing the updated version of the rotation to the rotation table, the updated version of the rotation being written as an additional entry to the plurality of versions of the rotation; generating a timeline for the task schedule based at least in part on the at least one historical version of the rotation and updated version of the rotation; and causing rendering of a graphical user interface (GUI) on a display of at least one computing device, the GUI comprising the timeline.

In some embodiments, the method further comprises generating a first portion of the timeline for the task schedule based at least in part on the at least one historical version of the rotation; and generating a second portion of the timeline based at least in part on the updated version of the rotation. In some embodiments, the timeline comprises a first layer and a second layer; the first layer is generated based at least in part on respective on-call times for a plurality of user entities associated with the rotation; and the second layer is generated based at least in part on the first layer and a respective on-call time associated with a user entity assigned to override or backup at least one of the plurality of user entities associated with the rotation.

In some embodiments, the method further comprises receiving, from a computing device and via an application programming interface (API), a request to report at least one user entity that is on-call for performing the task pursuant to an input task interval, the input task interval indicating one of a plurality of task intervals of the task schedule; generating a first interval map based at least in part on the first layer of the timeline and a second interval map based at least in part on the second layer of the timeline; determining, based at least in part on the second interval map, the at least one user entity that is on-call for performing the task pursuant to the input task interval; determining, based at least in part on the first interval map and the second interval map, i) at least one user entity that that was on-call for a historical task interval preceding the input task interval, and ii) at least one user entity that is on-call for a future task interval proceeding the input task interval; and provisioning, to the computing device and via the API, a report indicating the at least one user entity that is on-call for performing the task pursuant to the input task interval, the at least one user entity that that was on-call for the historical task interval preceding the input task interval, and the at least one user entity that is on-call for the future task interval proceeding the input task interval.

In some embodiments, the rotation comprises a listing of at least one user entity assigned to perform the task in accordance with the task schedule. In some embodiments, the method further comprises causing rendering of the GUI on a display of respective computing devices of at least a subset of the plurality of user entities. In some embodiments, the method further comprises receiving the at least one modification to the rotation from the at least one of the respective computing devices via an API. In some embodiments, the method further comprises generating a record of modifications to the rotation based at least in part on the updated version of the rotation, the at least one historical version of the rotation, and the timeline; and provisioning the record of modifications to at least one computing device.

In some embodiments, the rotation comprises a listing of at least one user entity assigned to perform the task in accordance with the task schedule; and the at least one modification to the rotation comprises at least one of i) a removal of a user entity from the listing, or ii) an addition of a user entity to the listing. In some embodiments, the at least one user entity comprises a first user entity assigned to perform the task and at least one additional user entity associated with supplementing the first user entity in performance of the task. In some embodiments, the rotation comprises a task interval associated with performance of the task pursuant to the task schedule; and the at least one modification to the rotation comprises an adjustment to the task interval.

In some embodiments, the rotation comprises a plurality of user entities assigned to perform the task in accordance with the task schedule; and a notification hierarchy for provisioning notifications to the plurality of user entities. In some embodiments, the method further comprises in response to writing the updated version of the rotation to the rotation table, generating an on-call event notification based at least in part on the updated version of the rotation; and provisioning the on-call event notification to a respective computing device of at least a subset of the plurality of user entities based at least in part on the notification hierarchy.

In accordance with another aspect, a second embodiment is provided. In one embodiment, the method comprises determining a subset of the plurality of on-call event notifications that is obsolete based at least in part on the at least one modification to the task schedule; removing the subset of the plurality of on-call event notifications from the task schedule; and provisioning, to at least one computing device, a remaining subset of the plurality of on-call event notifications in accordance with at least one task interval defined by the task schedule.

In some embodiments, the task schedule comprises at least one rotation; and the at least one modification comprises an update to the at least one rotation. In some embodiments, the update to the at least one rotation comprises an addition of at least one user entity to the at least one rotation. In some embodiments, the method further comprises generating at least one additional on-call event notification based at least in part on the at least one user entity and the at least one rotation; and provisioning the at least one additional on-call event notification to a respective computing device of the at least one user entity in accordance with the task schedule.

In some embodiments, the at least one rotation comprises respective contact data for at least one user entity assigned to performance a task in accordance with the task schedule; and the update to the at least one rotation comprises an update to the respective contact data. In some embodiments, the update to the at least one rotation comprises a deletion of respective contact data for at least one user entity associated with performing a task in accordance with the at least one rotation and the task schedule. In some embodiments, the update to the at least one rotation comprises an assignment of at least one user entity to the at least one rotation and an addition of respective contact data for the at least one user entity to the at least one rotation.

In some embodiments, the at least one modification comprises an addition of at least one rotation to the task schedule. In some embodiments, the at least one modification comprises a removal of at least one rotation from the task schedule. In some embodiments, the task schedule comprises at least one rotation and a respective override associated with the at least one rotation; the rotation comprises a first user entity assigned to perform a task in accordance with the task schedule; the override comprises a listing of at least one user entity assigned to replace the first user entity in performing the task; and the at least one modification comprises an update to the listing of the override. In some embodiments, the method further comprises obtaining the at least one modification to the task schedule from at least one communication channel of an asynchronous message delivery service.

In some embodiments, the modification comprises an addition of a user entity to a rotation of the task schedule. In some embodiments, the method further comprises obtaining a current version of the rotation from a rotation table, wherein: the current version of the rotation comprises an arbitrary time factor pursuant to notifying the user entity of an on-call event; generating an additional on-call event notification based at least in part on the current version of the rotation; and in accordance with the arbitrary time factor, provisioning the additional on-call event notification to a computing device of the user entity.

In accordance with another aspect, a computer program product is provided. The computer program product in some embodiments includes at least one non-transitory computer-readable storage medium having computer program code stored thereon. The computer program code in execution with at least one processor is configured for performing any one of the example computer-implemented methods described herein. In some embodiments, the at least one non-transitory computer-readable storage medium having computer program code comprising executable portions configured to: obtain from a rotation table a plurality of versions of a rotation for performing a task in accordance with a task schedule, wherein: the plurality of versions comprises at least one historical version of the rotation and a current version of the rotation; in response to a detection of at least one modification to the rotation, update the current version of the rotation to generate an updated version of the rotation; enable write access for the rotation table in response to the updated version of the rotation; and write the updated version of the rotation to the rotation table, the updated version of the rotation being written as an additional entry to the plurality of versions of the rotation.

Additionally, or alternatively, in some embodiments, the at least one non-transitory computer-readable storage medium having computer program code comprising executable portions configured to: obtain at least one modification to a task schedule, the task schedule comprising a plurality of on-call event notifications; determine a subset of the plurality of on-call event notifications that is obsolete based at least in part on the at least one modification to the task schedule; remove the subset of the plurality of on-call event notifications from the task schedule; and provision, to at least one computing device, a remaining subset of the plurality of on-call event notifications in accordance with at least one task interval defined by the task schedule.

In accordance with another aspect, an apparatus comprising at least one processor and at least one memory including computer program code is provided. The computer program code in execution with the at least one processor causes the apparatus to perform any one of the example computer-implemented methods described herein. In one embodiment, the at least one memory and the computer program code may be configured to, with the processor, cause the apparatus to: obtain from a rotation table a plurality of versions of a rotation for performing a task in accordance with a task schedule, wherein: the plurality of versions comprises at least one historical version of the rotation and a current version of the rotation; in response to a detection of at least one modification to the rotation, update the current version of the rotation to generate an updated version of the rotation; enable write access for the rotation table in response to the updated version of the rotation; and write the updated version of the rotation to the rotation table, the updated version of the rotation being written as an additional entry to the plurality of versions of the rotation.

In another embodiment, the at least one memory and the computer program code may be configured to, with the processor, cause the apparatus to: obtain at least one modification to a task schedule, the task schedule comprising a plurality of on-call event notifications; determine a subset of the plurality of on-call event notifications that is obsolete based at least in part on the at least one modification to the task schedule; remove the subset of the plurality of on-call event notifications from the task schedule; and provision, to at least one computing device, a remaining subset of the plurality of on-call event notifications in accordance with at least one task interval defined by the task schedule.

In accordance with another aspect, the apparatus includes means for performing each step of any of the computer-implemented methods described herein. In one embodiment, the apparatus includes means for obtaining from a rotation table a plurality of versions of a rotation for performing a task in accordance with a task schedule, wherein: the plurality of versions comprises at least one historical version of the rotation and a current version of the rotation; means for, in response to a detection of at least one modification to the rotation, updating the current version of the rotation to generate an updated version of the rotation; means for enabling write access for the rotation table in response to the updated version of the rotation; and means for writing the updated version of the rotation to the rotation table, the updated version of the rotation being written as an additional entry to the plurality of versions of the rotation.

In another embodiment, the apparatus includes mean for obtaining at least one modification to a task schedule, the task schedule comprising a plurality of on-call event notifications; means for determining a subset of the plurality of on-call event notifications that is obsolete based at least in part on the at least one modification to the task schedule; means for removing the subset of the plurality of on-call event notifications from the task schedule; and means for provisioning, to at least one computing device, a remaining subset of the plurality of on-call event notifications in accordance with at least one task interval defined by the task schedule.

### BRIEF DESCRIPTION OF THE SEVERAL VIEWS OF THE DRAWINGS

Having thus described some embodiments in general terms, references will now be made to the accompanying drawings, which are not drawn to scale, and wherein:

FIG. 1 is a block diagram of an example network environment in which a specially configured microservice schedule system may operate in accordance with one or more embodiments of the present disclosure.

FIG. 2 is a block diagram of an example apparatus that may embody the specially configured microservice schedule system in accordance with one or more embodiments of the present disclosure.

FIG. 3 shows an example data architecture in accordance with one or more embodiments of the present disclosure.

FIG. 4A shows a data flow for generating a timeline in accordance with existing approaches.

FIG. 4B shows a data flow for generating a timeline via the microservice schedule system in accordance with one or more embodiments of the present disclosure.

FIG. 5A shows a data flow for responding to a request for on-call user entities in accordance with existing approaches.

FIG. 5B shows a data flow for responding to a request for on-call user entities via the microservice schedule system in accordance with one or more embodiments of the present disclosure.

FIG. 6 shows an example task schedule interface that may be generated and rendered on a display of a computing device in accordance with one or more embodiments of the present disclosure.

FIG. 7 shows a flowchart diagram of an example process for conditionally writing a rotation version to a rotation table in accordance with at least some embodiments of the present disclosure.

FIG. 8 shows a flowchart diagram of an example process for managing and provisioning on-call event notifications in accordance with at least some embodiments of the present disclosure.

FIGS. 9A-B show charts of example performance in generating timelines in accordance with existing approaches and improved techniques described herein.

FIG. 10 shows a chart of demand peaks for on-call event notifications as observed in existing approaches.

### DETAILED DESCRIPTION OF VARIOUS EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Existing architectures for storing on-call rotations and timelines may demonstrate limited scalability and flexibility for accommodating schedule domains that are increasingly complex and computationally intensive. For example, existing approaches to generating a timeline may utilize different types of data to generate the historical and future portions of the timeline. Historical portions of the timeline may be generated based on persistent timeline-period items, whereas future portions of the timeline may be generated based on rotation configurations. The use of different calculation algorithms and datasets for calculating timeline portions may introduce complexity to adapting the architecture to increasingly large task schedules. For example, debugging and maintenance operations may not be generalizable across both historical and future timeline calculation methods. Additionally, existing approaches may generate the timeline on a periodic basis. In the context of historical timeline calculation, the persistence of timeline-period items in accordance with short periods (e.g., 1-hour, 30-minutes, and/or the like) may result in excessive input/output (I/O) operations to system databases. For example, in a context of hourly timeline calculation for a task schedule having two rotations, these approaches may write 26 timeline-period items to a database each day (e.g., 780 items being written to the database per month). As additional task schedules and more complex rotations are introduced, existing architectures may encounter throttling events and excessive data volumes.

To overcome these challenges, and others, the present methods, apparatuses, and computer program products provide an improved architecture for storing on-call rotations and generating timelines of task schedules. In various embodiments, the architecture and techniques described herein implement a unified structure for generating historical and future timeline portions based on a plurality of rotation versions. For example, the methods, apparatuses, and computer program products may to generate a historical portion of a timeline based at least in part on historical versions of a rotation and a future portion of a timeline based at least in part on a current version of the rotation. In various embodiments, the methods, apparatuses, and computer program products implement a rotation table for storing the historical rotation versions and current rotation version. In some embodiments, to the methods, apparatuses, and computer program products are configured to write updated rotation versions to the rotation table only in instances in which a modification is made to the rotation. In this manner, the present architecture and techniques may reduce data volume of and I/O requests to the databases. The homogenization of data structures for timeline generation and the minimization of data volume and I/O requests may improve operational efficiency and increase the capacity to accommodate more complex and multitudinous schedule workloads. Further, updated rotation versions may be written on top of the historical rotation versions such that the historical versions are maintained. In doing so, the methods, apparatuses, and computer program products may support maintenance and debugging for historical timeline periods.

Further, existing approaches may periodically record schedule history for an upcoming period, such as a succeeding day. In such contexts, a timeline may be calculated for the succeeding day, the timeline indicating user entities that are on on-call rotations (e.g., shift for handling a task) for the proceeding day and when the on-call rotations start and stop. The handoff points of the timeline (e.g., end of a first rotation and start of a second rotation) may be defined as on-call events, and a system event may be generated for representing one more on-call events. Such approaches may periodically evaluate system events to determine whether their associated activation time has occurred. In response to determining that the activation time has been reached, a plurality of checks may be performed. For example, historical approaches may determine i) whether a notification candidate (e.g., user entity) has enabled notifications, and ii) whether the organization and/or task schedule associated with the on-call rotation is configured to an active state. In a second example, such approaches may determine whether the version of the system event and/or on-call event represented thereby is up to date. In response to confirming the success of all checks, a schedule notification may be provisioned to the computing device of the user entity. In response to a failure of one or more checks, a schedule notification may be discarded.

The architecture of existing approaches may include a first portion, referred to as creation time, and a second portion, referred to as on-call event time. In such approaches, creation time denotes the creation of system events, which may occur periodically (e.g., daily schedule history recording) or in response to creation or modification of a rotation. During daily schedule history recording, existing approaches may generate new on-call events in accordance with the timeline of the proceeding day. When a rotation is created or modified, new on-call events may be introduced to the system event. The new on-call events may be missed (e.g., appropriate schedule notifications may fail to be delivered) in instances where the start time of the on-call event is before the next iteration of schedule history recording. For example, a new rotation may be created and include an on-call start time for a shift that transpires within an hour of the creation. In a context of daily schedule history recording, the new rotation may be unrecorded and, as a result, such approaches may fail to deliver appropriate schedule notifications to the user entities of the rotation.

In the existing approaches, on-call event time denotes the time when the on-call user entity of a rotation changes and a schedule notification must be sent to the next on-call user entity. Such approaches may perform a plurality of validations in response to determining the on-call event time has arrived. For example, a validation may include determining whether i) a notification rule is enabled or ii) an organization, task schedule, and/or rotation is active and enabled. As another example, a validation may include determining whether there are any new on-call events in the rotation that belong to the same rotation and render the current on-call event obsolete. In an example instance, if there is a new update to the rotation for which daily system events are already generated, and the update changes the current day's events (e.g., consider a rotation with a first user entity only, whose on-call starts in one hour, and a second user entity changes), then the prior generated on-call events become “obsolete”, meaning that they are not valid anymore and schedule notifications associated with the obsolete on-call events should not be provisioned.

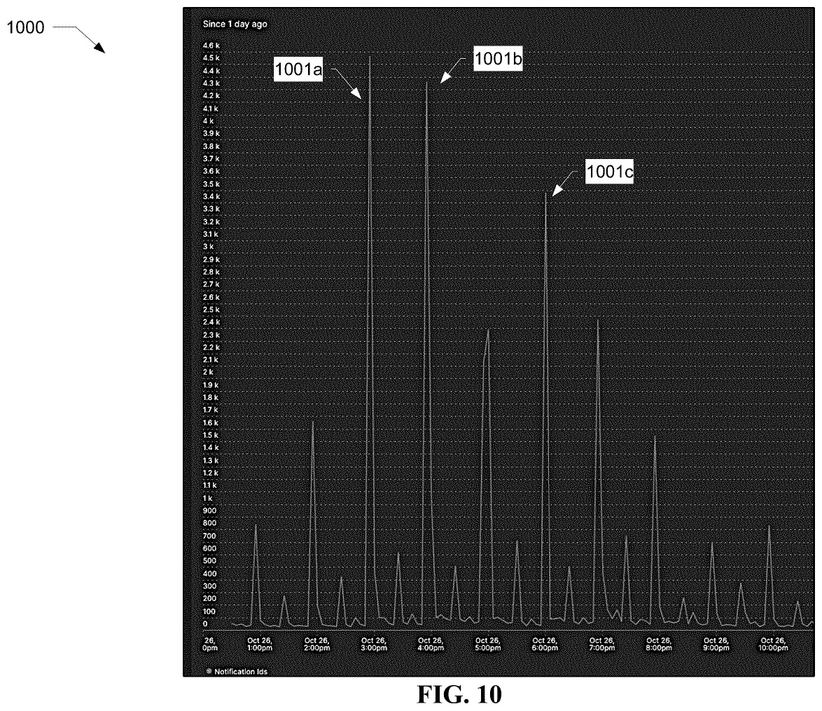

The above-described approaches and architecture demonstrate several drawbacks. First, the delegation of validation operations to on-call event time may result in system overload in instances high numbers of on-call events are occurring simultaneously or within short intervals of one another (e.g., many organizations undergoing a shift change around the same time interval). For example, the start of a business day for a given time zone (e.g., 9:00 AM Easter Time) may be associated with triggering thousands of schedule notification events as on-call times for a plurality of rotations of various organizations transpire. The chart 1000 shown in FIG. 10 further illustrates peaks 1001a-c of on-call notification activity that may be experienced throughout a workday as user entities of various organizations rotate between task intervals (see indica 1001a-c). The close temporal proximity of the schedule notification events may reduce efficiency and throughput of existing systems. Further, in such approaches, the performance of each validation operation requires multiple input/output (I/O) requests to one or more databases during notification firing, which may further increase computational workloads and degrade the speed of validation operations and provisioning of schedule notifications. Additionally, such high-load periods may result in throttling events.

To overcome these challenges, and others, the present methods, apparatuses, and computer program products provide an improved architecture for generating and validating schedule notifications. In various embodiments, the architecture and techniques described herein offload the on-call event time workloads for detecting obsolete on-call to creation time and/or update time (e.g., time that denotes a modification to a task schedule, rotation, user entity attribute, and/or the like). In some embodiments, the methods, apparatuses, and computer program products are configured to determine and discard obsolete on-call events during creation time and/or update time such that, when on-call event times transpire, no obsolete call-events remain. For example, for on-call events that are generated in accordance with a prior rotation version, the methods, apparatuses, and computer program products may filter the on-call events in accordance with the latest rotation version to determine and discard a subset of on-call events that are obsolete based on the latest rotation version. By doing so, the methods, apparatuses, and computer program products may avoid the excess I/O request issues observed in other approaches that typically validate notifications at on-call time. In this manner, the disclosed architecture and techniques may improve computational efficiency and throughput of generating and provisioning schedule notifications in accordance with task schedules, rotations, and/or the like.

### Definitions

As used herein, the terms “data,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, “application” refers to any program code executable by logic circuitry of one or more computing devices, such as a server processor. In some embodiments, an application is a computer program accessible to an entity via a computing device and which performs a specific function directly or indirectly for the entity, the computing device, another application, and/or the like. In some embodiments, an application includes a local software program installed and executed on a computing device accessible to an entity. In some embodiments, an application includes a remotely executed software program accessible to the entity via the entity's computing device and a suitable network connection to the corresponding remote computing environment.

Non-limiting examples of applications include local computer programs, remote computer programs, services, microservices, software modules, communication interfaces, and/or the like. In one example, an application may be a ticketing and project management service, such as Jira™. In another example, an application may be a cloud-based computing environment that enables collaborative workflows, such as Confluence™. In another example, an application may be a remote computing environment that provides program repository services, such as Bitbucket™. In still another example, an application may be an electronic mail (e-mail) and scheduling management platform. Other examples of applications include project visualization tools, incident management tools, user administration and authentication programs, collaborative work platforms, risk management and monitoring services, software testing tools, and/or the like. In some embodiments, application may refer to specific functions, features, services, and/or the like that are accessible using executable program code, or portion thereof. For example, application may refer to a specific functionality or action that may be performed using an application.

The term “database” refers to a repository, a datastore, and/or a memory device which is accessible by one or more computing devices for retrieval and storage of one or more data components, the like, or combinations thereof. The database may be configured to organize data components stored therein in accordance with one or more particular data classification labels or other attributes attributed to the data component (e.g., a scoring metric, file size, file type, etc.). For example, a database may be structured in accordance with one or more data components associated with one or more services, applications, data classification labels, internal resources, external resources, network functions, APIs, the like, or combinations thereof. In some embodiments, a database may be at least partially stored on one or more of a server, remotely accessible by a computing device, or on a memory device on-board the computing device. The terms database, repository, datastore, and memory device may be used interchangeably herein.

As used herein, the term “computing device” refers to computer hardware and/or software that is configured to facilitate investigation of anomalous activities. Computing devices may include, without limitation, smart phones, tablet computers, laptop computers, wearables, personal computers, enterprise computers, and the like.

As used herein, the term “task” refers to any work or responsibility that may be carried out by a user entity. For example, a task may comprise duties associated with monitoring and responding to cyber incidents. As another example, a task may include maintaining or operating a software application, web server, and/or the like. In still another example, a task may include fielding and responding to requests from a customer service portal. In various embodiments, a period of time during which a task is performed may be referred to as a “task interval.” For example, a task interval may embody a shift during which a user entity is responsible for performing a task. In some embodiments, a user entity that is responsible for performing a task pursuant to a particular period is referred to as being “on-call” for the task interval which represents the particular period. For example, a task may comprise monitoring and responding to cyber incidents, and a user entity may be on-call for responding to said cyber incidents in accordance with a start time and end time of a task interval.

A used herein, the term “schedule” refers to a data representation of tasks, task intervals associated with tasks, and entities assigned to be responsible for a task in accordance with the task interval. In various embodiments, a schedule comprises a plurality of rotations. In various embodiments, a rotation associated with a specific time is referred to as an “on-call rotation” of the schedule for the time and associated task.

As used herein, the term “rotation” refers to a data object that governs associations between tasks, task intervals, and entities. For example, a first rotation may include an assignment of a first entity to a task during a first task interval, and a second rotation may include an assignment a second entity to the same task during a second interval. The task interval may represent a duration during which the assigned entity is responsible for performing the task. In various embodiments, a task interval of a respective rotation includes a start time, an end time, a duration based at least in part on the start time and the end time, and/or the like. In various embodiments, a rotation comprising a task interval that falls within a current time period is referred to as an “on-call” rotation.

As used herein, the term “override” refers to a data object that defines an association between a task and task interval of a rotation and a secondary entity, who may serve as a replacement in instances of unavailability of a first entity assigned to the task in accordance with the task interval. For example, a rotation may include a task, a start time and end time for the task (e.g., a task interval), and a user identifier for a first user responsible for the task between the start time and end time. In such contexts, an override associated with the rotation may include a second user identifier for another user who may inherit responsibility for managing the task between the start time and end time in scenarios where the first user is removed from or incapable of managing the first task during the specified task interval.

As used herein, the term “timeline” refers to any time series representation of the rotations of a task schedule. For example, a timeline may include a time series of task intervals and respective on-call rotations for the task intervals. In various embodiments, a timeline includes a plurality of cells representative of discrete time periods (e.g., task intervals) of a task schedule. A timeline may include multiple layers. For example, the timeline may include a schedule layer including information related to on-call rotations and an override layer including information related to user entities (or groups thereof) that may replace or substitute user entities of on-call rotations. In such contexts, the timeline may include a final layer that based at least in part on the schedule layer, the override layer, and potentially other layers. The final layer may be generated in accordance with a hierarchy such that respective user entities of different layers that are assigned to the same task interval may be conditionally selected and populated into the final layer. For example, pursuant to a task interval, and in accordance with a hierarchy, a group of user entities associated with the override layer may be populated into the final layer instead of a group of user entities from the schedule (e.g., both groups of user entities being assigned to the same task interval).

As used herein, the term “notification” refers to any electronic message that may be rendered on a display of a computing device. For example, a notification may include electronic mail, push alerts, short message service (SMS) texts, instant messages, pop-ups, telephone calls, and/or the like. In some embodiments, a notification is provisioned to a computing device to cause rendering of the notification on a display of the computing device. Alternatively, or additionally, in some embodiments, a notification is provisioned to an application such that a computing device may view or access the notification via the application. In some embodiments, a notification is provisioned to a user entity in advance of a task interval to which the user entity is assigned. In such contexts, the notification may be referred to as an “on-call event notification.” In various embodiments, the present methods, apparatuses, and computer program products enable the provision of on-call event notifications to user entities in accordance with customized time factors that are user-configurable. For example, on-call event notifications may be provisioned to user entities on an arbitrary basis pursuant to time delivery preferences of a user entity.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as computing devices of one or more user entities assigned to perform tasks in accordance with a task schedule. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

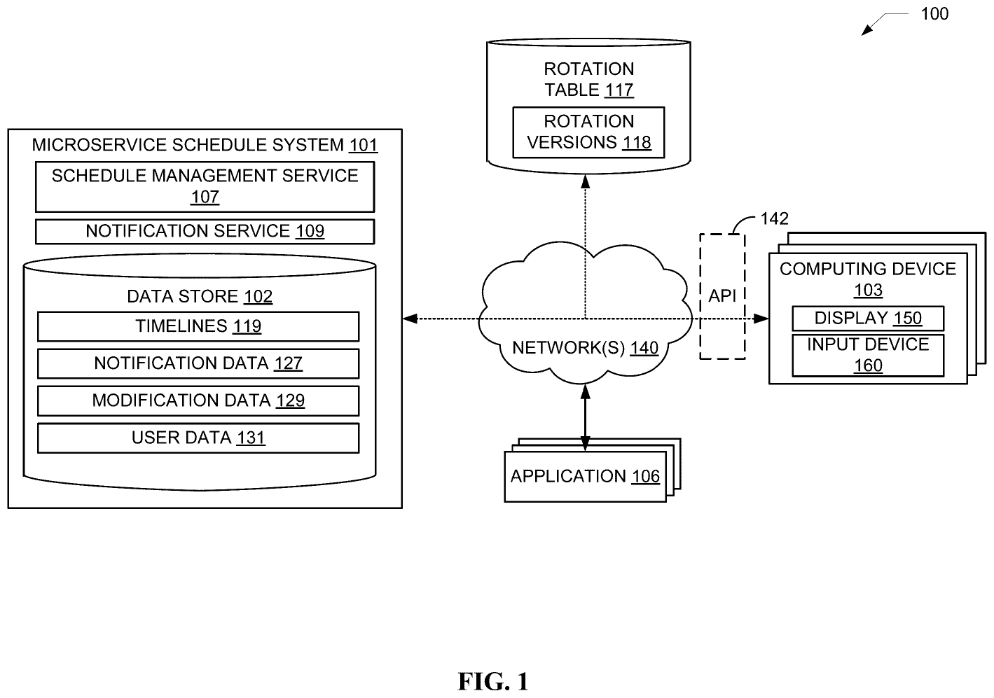

FIG. 1 illustrates an example network environment 100 in which a specially-configured microservice schedule system may operate in accordance with one or more embodiments of the present disclosure. In some embodiments, the network environment 100 includes an microservice schedule system 101 configured to communicate with other elements of the network environment 100 via one or more networks 140. In some embodiments, other elements of the network environment 100 include one or more computing devices 103, rotation tables 117, applications 106, and/or the like. In some embodiments, a computing device 103 is associated with a user entity. For example, a plurality of computing devices 103 may be associated with a plurality of members of a labor unit, such as a team of engineers, analysts, technicians, developers, and/or the like. In various embodiments, the microservice schedule system 101 is configured to detect events in one or more applications 106, computing devices 103, and/or the like. For example, the microservice schedule system 101 may obtain interactions between applications 106 and computing devices 103 to detect changes to task schedules, rotation versions 118, user data 131, and/or the like. For example, the microservice schedule system 101 may be configured to process inputs provided by user entities to one or more computing devices 103, where the inputs may affect changes to task schedules, rotations, user preferences, notification forwarding policies, notification hierarchies, and/or the like. In various embodiments, data that is representative of changes to rotation versions 118, user data 131, and/or the like may be referred to as modification data 129.

In various embodiments, the microservice schedule system 101 is configured to perform operations and carry out functions described herein for generating, maintaining, and updating rotation versions 118 and notification data 127, and for generating and provisioning on-call event notifications to the computing devices 103. For example, the microservice schedule system 101 may generate and write updates to a rotation version 118 at a rotation table 117 in response to detecting a modification to a task schedule. In such contexts, the task schedule may comprise one or more rotations defined in accordance different task intervals, start times, stop times, groups of user entities, and/or the like. For example, the task schedule may include a first “primary” rotation, a second “backup” rotation, and, potentially, one or more overrides (e.g., the backup rotations and overrides comprising listings of user entities that replace user entities of the primary rotation). The microservice schedule system 101 may detect a modification to the primary rotation, backup rotation, override, and/or the like, and write an update to a latest rotation version 118 at the rotation table 117 with which the task schedule is associated.

In some embodiments, the microservice schedule system 101 is configured to generate timelines 119 based at least in part on one or more rotation versions 118. A timeline 119 comprise a time series of scheduled tasks in accordance with one or more rotation versions 118. In some embodiments, a timeline 119 may be provided within a graphical user interface (GUI) rendered on a display 150 of a computing device 103. In various embodiments, the notification service 109 is configured to generate notification data 127 based at least in part on the rotation versions 118. The notification data 127 may include a plurality of on-call event notifications, which the microservice schedule system 101 may provision to computing devices 103. For example, based on a configured time factor (e.g., 2 weeks, 1 month, 3 weeks, 2 days, 30 minutes, and/or the like) the notification service 109 may provision on-call event notifications to respective computing devices 103 of the user entities assigned to a rotation. As another example, the microservice schedule system 101 may enable user entities to access and view respective on-call timelines of a plurality of schedules in accordance with current rotation versions 118.

In various embodiments, the notification service 109 is configured to determine and remove on-call event notifications that are rendered obsolete by changes to a rotation, task schedule, user data 131, and/or the like. For example, based at least in part on a modification to a rotation version 118, the notification service 109 may determine a subset of existing on-call event notifications for the rotation that are made obsolete by the modification. The notification service 109 may discard the obsolete on-call event notifications such that, at event time, only valid on-call event notifications remain available for sending. In various embodiments, obsolescence of a notification includes any instances in which the contents, scheduled delivery, or configured targets of the notification are rendered inaccurate by a modification to the rotation, task interval, user entities, and/or the like with which the notification is associated. For example, an on-call event notification may be generated in accordance with a task interval such that the on-call event notification is scheduled for delivery in advance of the task interval (e.g., 1 day prior, 2 weeks prior, 36 hours prior, and/or the like. In such contexts, a modification to the start time of the task interval may result in the on-call event notification being obsolete. As another example, an on-call event notification may be generated in accordance with a rotation, a plurality of entities assigned to the rotation, and respective user contact information for the plurality of user entities. In such contexts, an addition or removal of a user entity or a modification to user contact information may result in obsolescence of the on-call event notification.

In some embodiments, the microservice schedule system 101 is configured to generate an on-call representation of a schedule based at least in part on a time interval, task, and/or the like. In various embodiments, the on-call representation of a schedule comprises a subset of the schedule that is associated with one or more factors including task interval, task, user entity (or group of user entities), and/or the like. For example, via a network 140 and application programming interface (API) 142, the microservice schedule system 101 may receive from the computing device 103 a user input comprising or selecting a time interval (e.g., a date, start and end time within the data, and/or the like). As another example, the microservice schedule system 101 may receive from the computing device 103 a user input comprising or selecting an identifier associated with one of a plurality of tasks. In such contexts, in response to the user input, the microservice schedule system 101 may generate a task schedule interface based at least in part a rotation version 118 determined in accordance with the time interval, task, and/or the like. The task schedule interface may include a timeline 119 comprising one or more rotations (e.g., individual user entities or groups of entities responsible for the task within the time interval), rotation overrides (e.g., additional entities that may replace or supplement other entities), user data 131 (e.g., email address, phone number, username, and/or the like), and/or the like. In various embodiments, the microservice schedule system 101 is configured to perform operations for on-call calculation within workflows for generating and routing schedule notifications. For example, the microservice schedule system 101 may carry out such functions to provision on-call event notifications to entities that are on-call for a task based at least in part on the timeline 119, current rotation version 118, and/or the like.

Previous approaches to generating on-call representations, timelines, and schedule notifications may demonstrate limited flexibility and scalability. For example, previous architectures may generate a historical portion of a timeline using previously persistent timeline-period items in a database. In such approaches, a timeline-period item may be a data object comprising a start time and an end time of a task and information that identifies one or more user entities assigned to perform the task in accordance with the start time and end time. For example, the timeline-period item may define an on-call responder of a rotation between the start time and end time of the task. These historical approaches may generate timeline-period items in accordance with a current data and an additional interval (e.g., 2 days) to ensure that the history is readily available.

In an example scenario of performing the above calculations for a 2-day interval and in accordance with an on-call interval that is longer than 2 days (e.g., a user entity is on-call in a rotation for an interval longer than 2 days), historical approaches may write different portions of the on-call period to a database in each calculation iteration. Such approaches may merge the various portions together in generating a timeline for the on-call interval. Thus, even in instances of an on-call interval with a lengthy or infinite interval not ending in the next 2 days, these historical approaches may write an entry to the associated database each day. However, for less lengthy on-call intervals (e.g., hourly or semi-hourly intervals), such approaches may generate excessive numbers of input/output operations to the database.

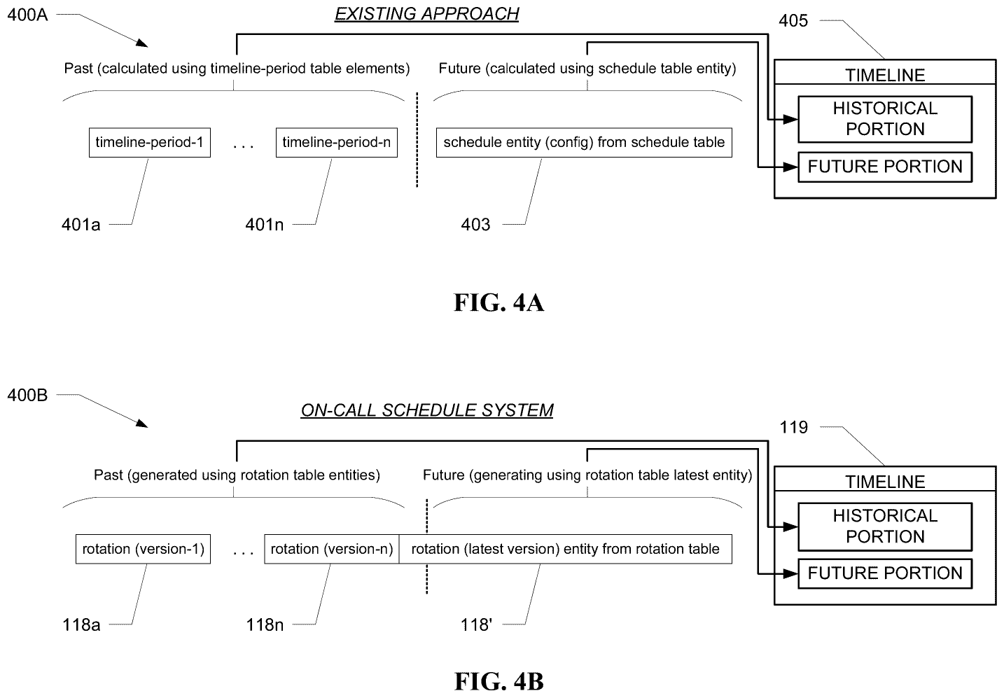

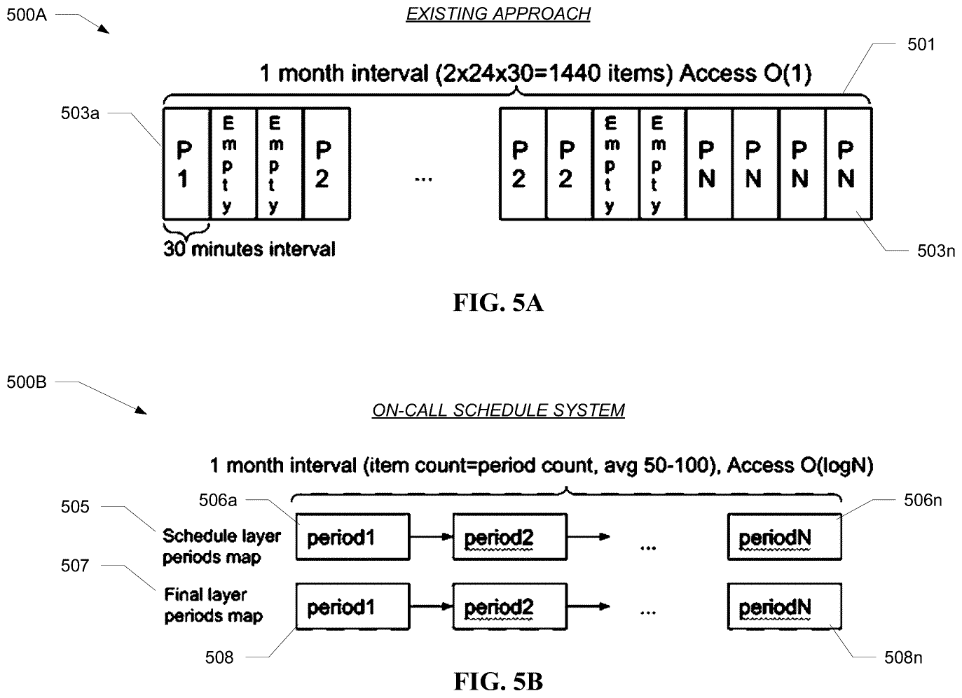

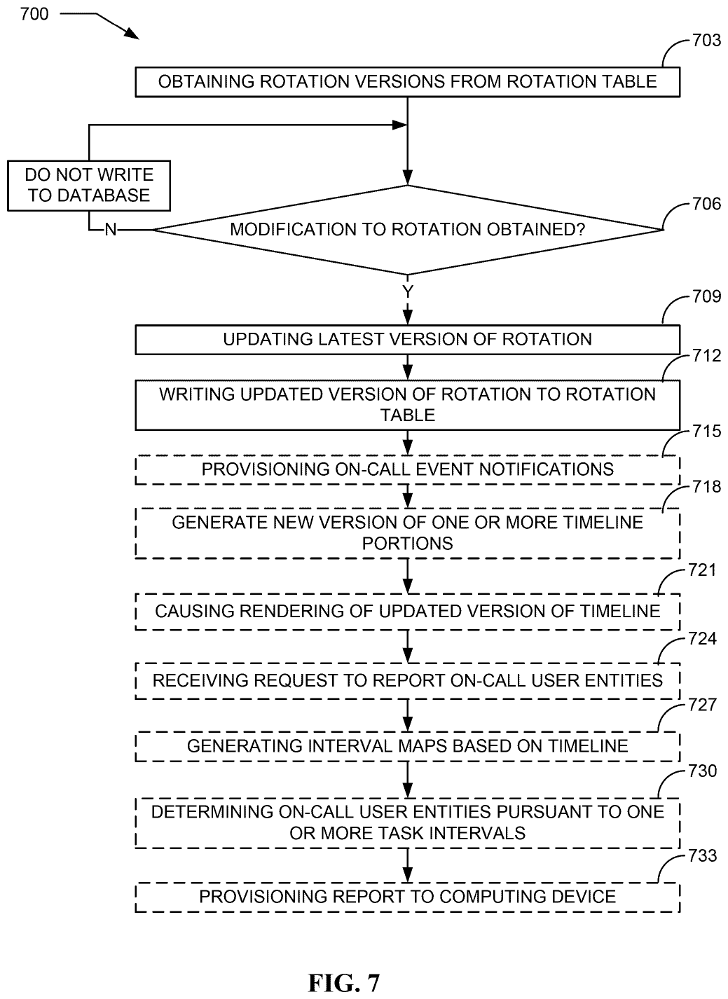

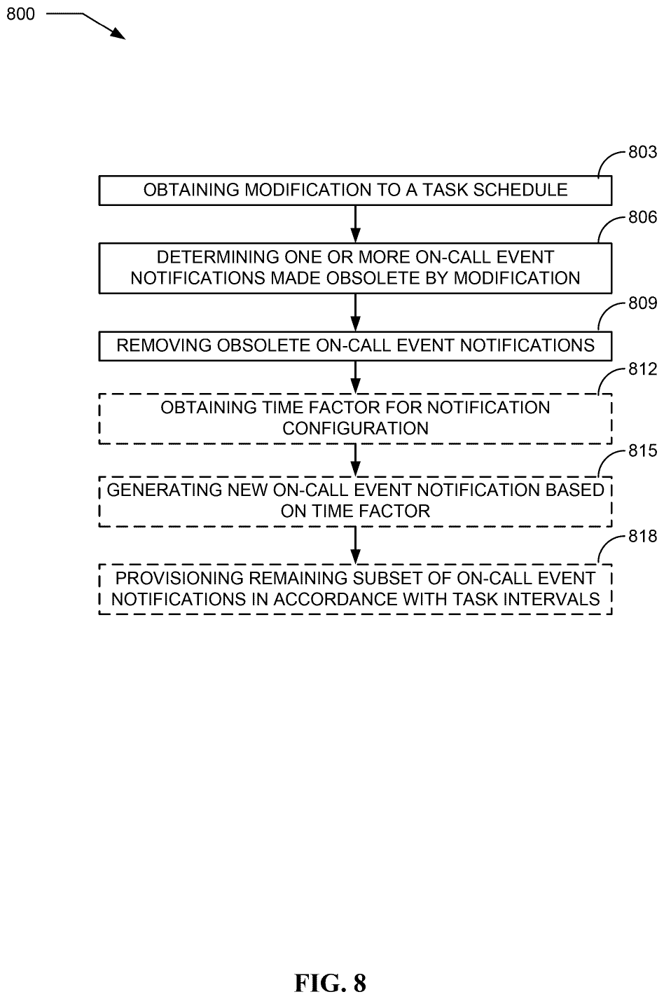

In various embodiments, the microservice schedule system 101 is configured to carry out data flows and perform one or more processes for updating rotation versions 118 and generating on-call event notifications. For example, the microservice schedule system 101 may carry out data flows 400B, 500B shown in FIGS. 4B and 5B, respectively, and described herein. As another example, the microservice schedule system 101 may carry out processes 700, 800, shown in FIGS. 7 and 8, respectively, and described herein.

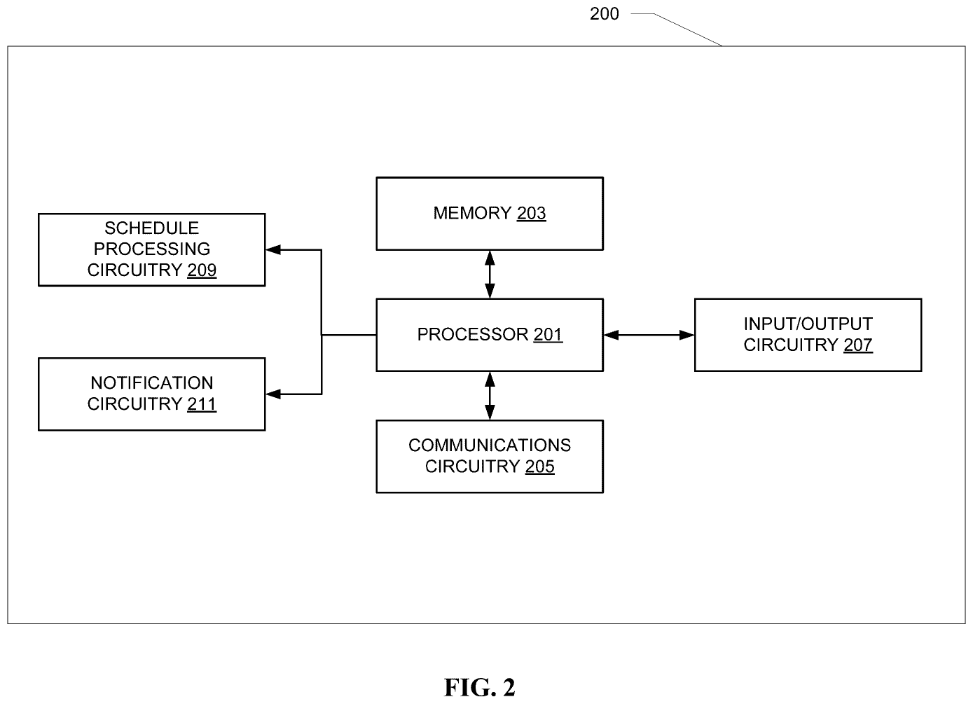

In some embodiments, the microservice schedule system 101 is embodied as, or includes one or more of, an apparatus 200 (e.g., as further illustrated in FIG. 2 and described herein). Various applications and/or other functionality may be executed in the microservice schedule system 101 and/or apparatus 200 according to various embodiments. In some embodiments, the microservice schedule system 101 includes, but is not limited to, a schedule management service 107, notification service 109, one or more data stores 102, and/or the like. The elements of the microservice schedule system 101 can be provided via a plurality of computing devices that may be arranged, for example, in one or more server banks or computer banks or other arrangements. Such computing devices can be located in a single installation or may be distributed among many different geographical locations. For example, the microservice schedule system 101 can include a plurality of computing devices that together may include a hosted computing resource, a grid computing resource, and/or any other distributed computing arrangement. In some cases, the microservice schedule system 101 can correspond to an elastic computing resource where the allotted capacity of processing, network, storage, or other computing-related resources may vary over time.

In some embodiments, the microservice schedule system 101 includes one or more data stores 102. The various data in the data store 102 may be accessible to elements of the microservice schedule system 101, including the schedule management service 107, notification service 109, or an apparatus 200 embodying the one or more system elements. The data store 102 may be representative of a plurality of data stores 102 as can be appreciated. The data stored in the data store 102, for example, is associated with the operation of the various applications, apparatuses, and/or functional entities described herein. The data stored in the data store 102 may include, for example, timelines 119, modification data 129, user data 131, and/or the like. The data store 102 may include one or more storage units, such as multiple distributed storage units that are connected through a computer network. Each storage unit in the data store 102 may store at least one of one or more data assets and/or one or more data about the computed properties of one or more data assets. Moreover, each storage unit in the data store 102 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In various embodiments, the microservice schedule system 101 is configured to write data to and read data from one or more rotation tables 117. In some embodiments, a rotation table 117 is associated with a remote computing environment that is external to the microservice schedule system 101 or one or more elements thereof, such as the schedule management service 107. For example, the schedule management service 107 may be configured to write rotation versions 118 to the rotation table 117 via one or more networks 140. In some embodiments, the rotation table 117 is stored at a distributed digital storage environment, such as cloud storage, and/or the like. Additionally, or alternatively, in some embodiments, the rotation table 117 is internal to the microservice schedule system 101. The rotation table 117 may be representative of a plurality of databases as can be appreciated.

In various embodiments, the rotation table 117 is configured to store rotation versions 118. For example, the rotation table 117 may store a latest rotation version 118 (also referred to herein as a “current version” of a rotation) and one or more historical rotation versions 118. In various embodiments, the schedule management service 107 is configured to write new or updated rotation versions 118 as an additional entry to the rotation table 117 such that historical rotation versions 118 are preserved. In some embodiments, the schedule management service 107 is configured to write an updated rotation version 118 to the rotation table 117 only when there is a change to the rotation or respective user data 131 associated with user entities assigned to the rotation. For example, the write access of the schedule management service 107 pursuant to the rotation table 117 may be disabled unless a change to the rotation is detected. In response to the microservice schedule system 101 detecting an addition or removal of a user entity from a rotation, the write access of the schedule management service 107 may be enabled to permit the schedule management service 107 to write an updated rotation version 118 to the rotation table 117. As another example, the write access of the schedule management service 107 may be enabled in response to the microservice schedule system 101 detecting a change to the name of the rotation or associated task schedule, a change to a task interval associated with the rotation, an enablement or disablement of the task schedule, and/or the like. As compared to existing approaches, the conditional persistence of rotation versions 118 at the rotation table 117 based on detection of changes may reduce the number of I/O operations performed on the repository of rotation information.

For example, a task schedule may include a first rotation and a second rotation. The first rotation may include on-call periods that rotate twice per day, and the second rotation may include on-call periods that rotate each hour. In such contexts, historical approaches may generate and write, to a related database, 26 total timeline-periods (e.g., 2 timeline periods for the first rotation and 24 timeline periods for the second rotation). In this scenario, by persisting 26 timeline-period items each day, such approaches may generate 780 timeline-period items per month for the schedule. The high number of per-schedule timeline periods generated may limit the scalability of such architectures due to the significant increases in database input/output operations as additional schedules are processed via the periodic-focused techniques. For example, such approaches may result in overpopulation of rotation tables 117 with redundant information.

Instead of storing timeline-periods periodically, the schedule management service 107 is configured to avoid the excess database writing issues of other approaches at least in part by conditionally writing rotation versions 118 to the rotation table 117 and generating a historical portion of a timeline 119 using persisted rotation versions 118. In doing so, the schedule management service 107 may significantly reduce the number of database input/output operations performed as compared to other approaches. In various embodiments, the schedule management service 107 is configured to write an updated rotation version 118 to the rotation table 117 only in instances where the microservice schedule system 101 determines that there is a change to the rotation (e.g., addition or removal of a user entity other responder, schedule or rotation name change, enablement or disablement of the schedule, and/or the like). In response to determining that no changes have occurred, the schedule management service 107 may refrain from provisioning I/O requests to the rotation table 117 (e.g., write access may remain disabled), thereby avoiding redundant writing to the rotation table 117. In the context of the preceding section, instead of generating 780 items per month, the conditional techniques applied by the schedule management service 107 may result in writing of 2-3 versions of a rotation version 118 to the rotation table 117 (e.g., based on historical averages of the number of times a rotation is modified on a monthly basis).

In some embodiments, notification data 127 comprises on-call event notifications and parameters for provisioning on-call event notifications to computing devices 103 in accordance with a task schedule. For example, via an application 106 and computing device 103, a user entity may generate an on-call task schedule and a plurality of rotation versions 118 for performing one or more tasks in accordance with the on-call task schedule. The microservice schedule system 101 may access the latest rotation version 118, which includes one or more on-call user entities that require notification in advance of the on-call event time (e.g., start of a shift for performing the task). Further, provision of the notification may be required within a predetermined range of the task interval start time. In various embodiments, the notification data 127 includes on-call event notifications that were generated in accordance with a historical rotation version 118. In some embodiments, the notification service 109 is configured to filter the on-call event notifications based at least in part on a current rotation version 118 to determine and discard on-call event notifications that are rendered obsolete by the current rotation version 118.

In some embodiments, in association with a task schedule or rotation, the notification data 127 includes one or more notification policies for configuring when schedule notifications are provisioned to user entities of a rotation. In some embodiments, a respective notification policy defines a time factor for provisioning an on-call event notification to a user entity in advance of a start time of a task interval. The notification service 109 may enable provision of on-call event notifications on an arbitrary basis, whereas existing approaches may be limited to provisioning on-call event notifications for a fixed time factor, such as 1 day in advance. For example, the time factor may include 2 weeks, 3 weeks, 4 weeks, 2 days, 1 hour, 30 minutes, 15 minutes, 30 seconds, and/or the like before the start time of the task interval. In some embodiments, notification policy defines multiple intervals for provisioning notifications to a user entity in advance of a task interval start time. For example, one or more notification policies may include provisioning a first on-call event notification 2 weeks before a task interval and a second on-call event notification seconds before the task interval start time.

In some embodiments, modification data 129 includes inputs, messages, actions, and/or the like that define changes to a rotation, user data 131 that is associated with user entities assigned to the rotation, a task schedule with which the rotation is associated, and/or the like. For example, modification data 129 may include adjustments to task intervals, user contact information, members of a rotation (e.g., addition or removal of a user entity to a rotation), and/or the like. Additionally, in some embodiments, the modification data 129 includes changes to user data 131 pursuant to one or more user entities. For example, modification data 129 may include adjustments to user contact information, notification preferences, and/or the like. In various embodiments, the microservice schedule system 101 is configured to obtain the modification data 129 from one or more computing devices 103, applications 106, and/or the like. For example, the microservice schedule system 101 may be configured to obtain activity of an asynchronous message delivery service to detect for changes to task schedules, rotation versions 118, user preferences, and/or the like.

In some embodiments, user data 131 includes data associated with user entities that may perform tasks in accordance with a task schedule. In some embodiments, user data 131 includes contact information for respective computing devices 103, accounts, and/or the like, of the user entities. For example, the user data 131 may include phone numbers, usernames, email addresses, handles, and/or the like. In some embodiments, the user data 131 includes preferences for notification settings. For example, the user data 131 may include preferences for advance notification of task intervals for which the user entity is assigned to an on-call rotation. As another example, the user data 131 may include preferences for a frequency of notification (e.g., monthly, weekly, daily, hourly, 15-minute, 30-minute, and/or the like), type of notification (e.g., email, push alert, SMS text, phone call, instant message, and/or the like), a hierarchy of provisioning notifications amongst a group of user entities, and/or the like.

In various embodiments, based at least in part on modification data 129, a schedule management service 107 of the microservice schedule system 101 is configured to generate an update to a current rotation version 118 (e.g., the latest version of the rotation) and write the updated rotation version 118 to the rotation table 117. For example, the schedule management service 107 may carry out data flows 400B, 500B shown in FIGS. 4B, 5B and the process 700 shown in FIG. 7 as described herein. Additionally, or alternatively, in some embodiments, a notification service 109 of the microservice schedule system 101 is configured to process on-call event notifications and discard obsolete notifications in response to and based at least in part on one or more modifications to rotations, task schedules, and/or the like. For example, the notification service 109 may perform the process 800 shown in FIG. 8 and described herein.

The computing device 103 includes one or more computing device(s) accessible to a user entity and configured to present or provide access to information associated with task scheduling. In some embodiments, a computing device 103 is representative of user devices that receive on-call event notifications and interact with applications 106 to perform tasks and access application services. In some embodiments, the computing device 103 includes a personal computer, laptop, smartphone, tablet, Internet-of-Things enabled device, smart home device, virtual assistant, alarm system, workstation, work portal, and/or the like. The computing device 103 may include one or more displays 150, one or more visual indicator(s), one or more audio indicator(s) and/or the like that enables output of information to the particular entity. For example, the microservice schedule system 101 may cause provision of a task schedule interface to the computing device 103, and the computing device 103 may render the task schedule interface on the display 130. In some embodiments, the computing device 103 includes one or more input devices 160 for receiving user inputs, such as modifications to task schedules or rotations or requests to report on-call user entities for one or more task intervals. In some embodiments, the input device 160 includes one or more buttons, cursor devices, touch screens, including three-dimensional-or pressure-based touch screens, camera, fingerprint scanners, accelerometer, retinal scanner, gyroscope, magnetometer, and/or other input devices.

The application 106 is a computer program accessible to a user entity (e.g., a human user or another computing entity) via a computing device and which performs a specific function directly or indirectly for the entity, the computing device, another application, and/or the like. In various embodiments, an application 106 is associated with one or more task schedules. For example, a task schedule may include a plurality of task intervals for performing a task within an application 106 and a plurality of rotations comprising user entities assigned to perform the task pursuant to the task intervals.

The network 140 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 140 may include a cellular telephone, an 802.11, 802.16, 802.20, and/or WiMax network. Further, the network 140 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of a group-based communication system. In some embodiments, the protocol is a custom protocol of JavaScript Object Notation (JSON) objects sent via a Websocket channel. In some embodiments, the protocol is JSON over RPC, JSON over REST/HTTP, and the like. In various embodiments, an application programming interface (API) 142 embodies one or more interfaces and associated functions that enable communication between the microservice schedule system 101 and the computing devices 103 or applications 106. For example, the API 142 may enable communication between the microservice schedule system 101 and the computing devices 103.

### Exemplary Apparatus

The microservice schedule system 101 may be embodied by one or more computing systems, such as apparatus 200 shown in FIG. 2. The apparatus 200 may include processor 202, memory 204, input/output circuitry 206, communications circuitry 208, schedule processing circuitry 209, and notification circuitry 211. The apparatus 200 may be configured to execute the operations described herein. Although these components 202-211 are described with respect to functional limitations, it should be understood that the particular implementations necessarily include the use of particular hardware. It should also be understood that certain of these components 202-211 may include similar or common hardware. For example, two sets of circuitries may both leverage use of the same processor, network interface, storage medium, or the like to perform their associated functions, such that duplicate hardware is not required for each set of circuitries. The various services and processing units of the microservice schedule system 101 may be embodied individually or collectively by one or more of the circuitries 202-211. For example, the described functionality of the schedule management service 107, notification service 109, and/or the like may be performed by one or more of the processor 202, input/output circuitry 206, communications circuitry 208, schedule processing circuitry 209, or notification circuitry 211.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure. For example, the memory 204 may store contents of the data store 102 shown in FIG. 1 and described herein. Additionally, or alternatively, the memory 204 may store contents of one or more rotation tables 117 shown in FIG. 1 and described herein.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud”processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may include a user interface and may include a display, and may include a web user interface, a mobile application, a computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry including the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae. In some embodiments, the communications circuitry 208 performs functionality of the schedule management service 107, notification service 109, and/or the like. For example, the communications circuitry 208 may comprise or utilize one or more APIs to obtain read or write data to or from rotation tables, receive requests from computing devices, provision notifications and other schedule-related information to computing devices, and/or the like. In some embodiments, the communications circuity 208 may include circuitry for generating a response to a request for information on which user entities are on-call for a rotation, task interval, and/or the like. In some embodiments, the communications circuitry 208 may include circuitry for provisioning a schedule event notification to one or more computing devices.

The schedule processing circuitry 209 may be any means such as a device or circuitry embodied in either hardware or a combination of hardware and software that is configured to detect modifications to rotations, update rotation versions, generate schedule timelines based at least in part on rotation versions, and/or the like. The schedule processing circuitry 209 may embody one or more functionalities of schedule management service 107 as shown FIG. 1 and described herein. For example, the schedule processing circuitry 209 may generate a timeline of a task schedule based at least in part on one or more versions of the rotations associated with the task schedule. As another example, the schedule processing circuitry 209 may write an updated version of a rotation to a rotation table in response to determining that the rotation has been modified. In another example, the schedule processing circuitry 209 may determine not to write a version of the rotation to the rotation table in response to determining that no changes have been made to the rotation. In still another example, in response to a request for on-call information pursuant to a task interval of a task schedule, the schedule processing circuitry 209 may generate interval maps based at least in part on the timeline of the task schedule and determine on-call user entities for the requested task interval based on the interval maps.

The notification circuitry 211 may be any means such as a device or circuitry embodied in either hardware or a combination of hardware and software that is configured to generate on-call event notifications, determine obsolescence of on-call event notifications, and cause provision of on-call event notifications to one or more computing devices 103. The notification circuitry 211 may embody one or more functionalities of the notification service 109 as shown in FIG. 1 and described herein. For example, the notification circuitry 211 may detect one or more modifications to a task schedule and determine a subset of on-call event notifications of the task schedule that are rendered obsolete based at least in part on the modification. In such contexts, the notification circuitry 211 may obtain data from respective communications channels of one or more asynchronous message delivery services to detect for modification to rotations or respective user data of one or more user entities associated with the rotation. As another example, the notification circuitry 211 may discard obsolete on-call event notifications and generate additional on-call event notifications based at least in part on the modifications to the rotation, user data, and/or the like.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Data, Data Flows, and Operations

To address some of the shortcomings of various existing approaches to scaling infrastructure for schedule management and notification, various embodiments of the present disclosure provide techniques for efficiently updating on-call rotations and generating on-call event rotations. By utilizing the noted techniques for updating rotations, timelines, and on-call notifications of a task schedule, various embodiments of the present disclosure reduce the data volume of and optimize I/O requests to a rotation table. In doing so, the noted embodiments of the present disclosure can eliminate redundant or recurring data and reduce frequency of slowdown events (e.g., throttling, rate limiting, and/or the like) under increasing schedule management workloads. Accordingly, various embodiments of the present disclosure improve computational resource efficiency, flexibility, and scalability.

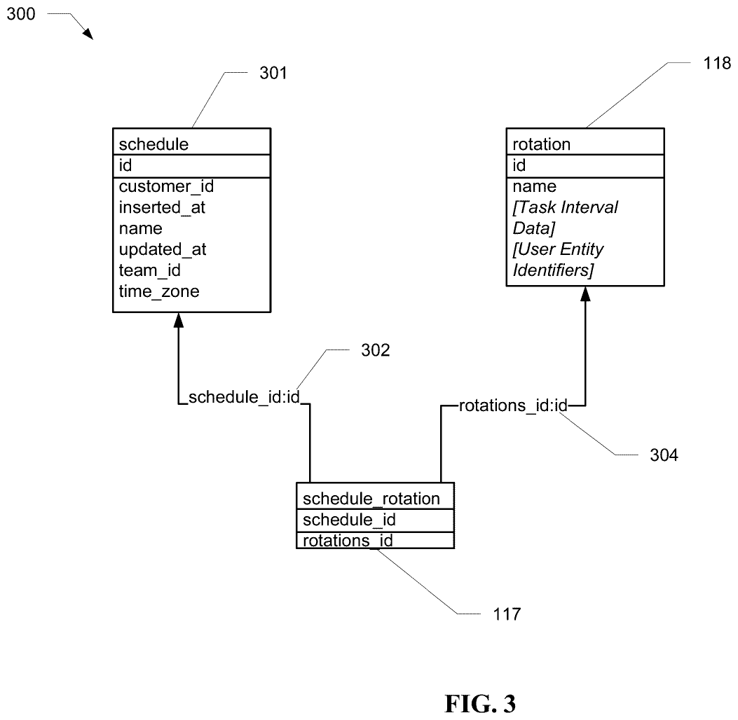

In some embodiments, the systems and/or apparatuses described herein maintain data environment(s) that enable the workflows in accordance with the data architectures described herein. For example, in some embodiments, the systems and/or apparatuses described herein function in accordance with the data architectures depicted and described herein with respect to FIG. 3 are maintained via the apparatus 200.

FIG. 3 shows an example data architecture 300 in accordance with one or more embodiments of the present disclosure. In various embodiments, the data architecture 300 illustrates elements of task schedules and rotation versions. In various embodiments, the schedule representation 301 comprises data associate with a task schedule. For example, the schedule representation 301 may comprise any number of data elements for identifying a task schedule, an organization affiliated with the task schedule, one or more user entities (or teams thereof) assigned to the task schedule, a time zone in which the task schedule is being implemented, and/or the like. For example, the schedule representation 301 may comprise a plurality of fields including an id field that uniquely identifies the task schedule, a customer_id field that uniquely identifies an organization associated with the task schedule, a name field comprising a title of the task schedule, a team_id field that uniquely identifies a set of user entities assigned to the task schedule, and a time_zone field that indicates a time zone of the schedule. The schedule representation 301 may further comprise an inserted_at field that represents a creation time of the task schedule, an updated_at field that represents a most recent timestamp at which the task schedule was updated, and/or the like.

In some embodiments, a rotation table 117 comprises an identifier for the task schedule and respective identifiers for historical and current rotation versions 118 that are associated with the task schedule. In some embodiments, the rotation version 118 includes a unique identifier, a title, and/or the like. The rotation version 118 may further include unique identifiers for one or more user entities assigned to the rotation. In some embodiments, the rotation version 118 includes one or more fields that define a task interval with which the rotation is associated. For example, the rotation version 118 may include a field that defines a period at which an on-call rotation changes from a first rotation to a second rotation. In various embodiments, a respective association between a schedule representation 301 and a rotation table 117 is represented by a schedule-rotation identifier 302. In some embodiments, the schedule-rotation identifier 302 is a concatenation of a unique identifier for the schedule representation 301 and a unique identifier for the rotation table 117. In some embodiments, a respective rotation version 118 is represented by a rotation version identifier 304. The rotation version identifier 304 may be a concatenation of identifiers including the identifier for the rotation table 117, a unique identifier for the rotation version 118, and a unique identifier for the rotation version 118.

FIG. 4A shows a data flow 400A for generating a timeline in accordance with existing approaches. Existing approaches may utilize two different structures to generate components of a timeline 404 for a task schedule. First, a historical portion of the timeline 405 is calculated based on elements from a timeline-period table. The timeline-period table may include exact period items. In such contexts, a period may represent a task interval of the task schedule. As an example, such approaches may calculate a historical portion of the timeline 404 based on exact period items 401a through 401n. In the existing approaches the timeline-period items may be updated on a daily basis (e.g., every 24 hours). Additionally, the timeline-period items may be updated or created when a task schedule, rotation, rotation responders (e.g., user entities, groups or teams of user entities, hierarchies of user entities, and/or the like) are added, updated or deleted. Further, existing approaches create the timeline-periods in accordance with a current date and interval extending 2 days from the current date to avoid delays in readily accessing the history of the task schedule.

Second, a future portion of the timeline 404 is calculated based on a schedule entity table 403, which may include rotation configurations for the task schedule. The timeline 404 is subsequently calculated based on the historical portion and the future portion. Thus, existing approaches use two different structures to calculate the past and future portions of the timeline 404 (e.g., timeline-periods and schedule table entities, respectively). The management of two different structures to generate a single timeline may introduce additional complexity to the data flow 400A and reduce the efficiency of debugging operations, tracking rotation updates, identifying updated attributes, detecting rotation deletions, and/or the like. Further, the periodic updating of timeline-periods causes frequent and recurrent generation of data, which introduces additional I/O requests to the database. In such contexts, the periodically generated data may also be redundant with past generated data.

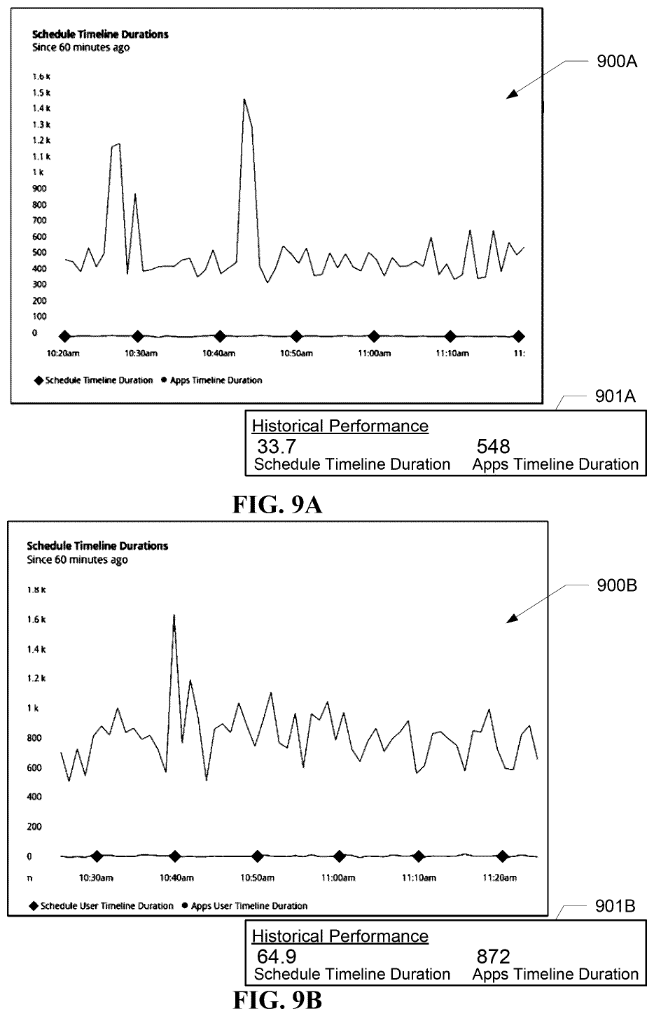

FIG. 4B shows a data flow 400B for generating a timeline via the microservice schedule system in accordance with one or more embodiments of the present disclosure. In various embodiments, the microservice schedule system and techniques described herein introduce a single, unified structure for generating a timeline 119 of a task schedule. In some embodiments, the microservice schedule system 101 generates a historical portion of the timeline 119 based at least in part on the historical versions of a rotation 11a-n, which may be organized into a rotation table comprising historical versions and a latest version of a rotation. In some embodiments, the microservice schedule system generates the future portion of the timeline 119 based at least in part on a latest rotation version 118′. In various embodiments, the microservice schedule system is configured to write respective versions of the rotation to the rotation table only in instances where the microservice schedule system determines that a modification has been made to the rotation. In other words, the microservice schedule system may perform dynamic updates to the latest rotation table element and, in doing so, eliminate the need for periodic data writing operations. For example, if there are no changes to the task schedule, rotations, rotation responders, and/or the like, the latest rotation element is not updated and, thus, the need for a daily periodic data save operation is eliminated. In various embodiments, the reduction in data volume and elimination of unnecessary periodic data creation contributed to improved scalability of the microservice schedule system. For example, as compared to existing approaches, the on-call schedule may more effectively manage larger volumes of data without compromising performance. The increased scalability may ensure that the microservice schedule system efficiently handles growth and accommodates additional organizations or workloads. For example, as shown in the performance charts 900A, 900B of FIGS. 9A, 9B, the described techniques and schedule infrastructure may improve time complexity by a factor of 14× as compared to existing approaches (see indicia 901A, 901).

In various embodiments, the use of a single structure (e.g., a rotation table) for generating both historical and future portions of the timeline 119 simplifies architecture and operation management. For example, the unified structure may streamline operations and reduce complexity such that the schedule infrastructure and timeline data require less computational workload to maintain. Further, the removal of periodic data creation may eliminate the generation of unnecessary data and reduce overall data volume. The use of dynamic updating and avoidance of periodic data creation may increase the storage and processing efficiency of the microservice schedule system as compared to existing approaches. Additionally, the unified structure of the microservice schedule system may enable efficient functionality to track rotation updates, identify updated attributes, and detect rotation deletions. In doing so, the microservice schedule system may provide for more rapid maintenance and issue resolution as compared to existing approaches. For example, if defects or other issues are identified in the past portion of the timeline, the unified structure may enable correction of the identified issues and defects via migration. In such contexts, the migration may enable seamless updates and corrections to the historical data, thereby increasing accuracy and reliability of the data and timelines derived therefrom.

FIG. 5A shows a data flow 500A for responding to a request for on-call user entities in accordance with existing approaches. In existing approaches, when a request to identify user entities on-call for a schedule is received, an array 501 is calculated and stored in cache memory. The array may include a plurality of cells 503a-n that represent 30-minute intervals in a 1-month timeline. A respective cell in the array may comprise information associated with the on-call user entity in accordance with a final layer of the timeline for the task schedule (e.g., a final timeline product with additional applications, such as overrides or forwardings, applied over initial rotation data). Further, the cell may comprise information about the next and previous on-call user entity based on the schedule layer of the timeline for the task schedule. Based on the configuration of the task schedule, a subset of the cells may be empty, recurrent, and/or the like. In such approaches, when a specific date is provided in the request, the corresponding cell of the array is accessed in constant time (e.g., order O(1)). However, the empty and recurrent cells may introduce complexity to managing the task schedule and reporting on-call information. For example, the empty and recurrent cells may increase the data volume of the array and reduce efficiency of iterating over or indexing through the array to determine requested information. Additionally, such approaches may lack capability to provide next on-call information for the final layer of the timeline for the task interval. As a result, these approaches may be constrained to configure rotations with 30-minute precision dates (e.g., xx:00 or hh:30).

FIG. 5B shows a 500B data flow for responding to a request for on-call user entities via the microservice schedule system in accordance with one or more embodiments of the present disclosure. In various embodiments, the microservice schedule system is configured to generate two interval maps in response to receiving a request to report on-call user entities for a time interval of a task schedule. For example, the microservice schedule system may generate a first interval map 505 and a second interval map 507 and store the interval maps 505, 507 in cache memory. In some embodiments the microservice schedule system is configured to generate the first interval map 505 based at least in part on a schedule layer (e.g., “first layer”) of the timeline of the task schedule. In some embodiments the microservice schedule system is configured to generate the first interval map 505 based at least in part on a final layer (e.g., “second layer”) of the timeline of the task schedule. In such contexts, the schedule layer may include rotation-related on-call information, such as task intervals and rotations of one or more user entities assigned to respective task intervals. The final layer may be based at least in part on the schedule layer and additional rotation data including user entities assigned to act as overrides, backups, and/or the like for one or more rotations.

A respective interval map may include a plurality of cells, and a respective cell may represent an exact period of the timeline (e.g., 1-minute period, 15-minute, 30-minute period, 1-hour period, and/or the like). For example, the first interval map 505 may include a plurality of cells 506a-n and the second interval map 507 may include a plurality of cells 508a-n, each of which may represent exact periods of the timeline. The cells 506a-n, 508a-n may include rotation information, such as user entities of an on-call rotation assigned to the timeline period (e.g., task interval). The cells 508a-n may further include override and backup information, such as user entities assigned to serve as overrides or backups to the on-call user entities of a task interval. In various embodiments, in response to a request comprising a specific date (e.g., one of the plurality of task intervals of the task schedule), the microservice schedule system is configured to access the corresponding cell of the first interval map 505, the second interval map 507, and/or the like in logarithmic time (e.g., O(log N)). In some embodiments, the microservice schedule system is configured to generate a response to the request comprising on-call responder information based at least in part on the final layer of the timeline. In various embodiments, the response further comprises next responder information associated with a subsequent task interval of the task schedule and previous responder information associated with a preceding task interval of the task schedule. The next responder information and previous responder information may indicate user entities that were or will be on-call for the preceding or subsequent task interval (e.g., on-call user entities, backup user entities, override user entities, and/or the like). In some embodiments, the microservice schedule system is configured to generate the next responder information and previous responder information based at least in part on both the final layer and the schedule layer of the timeline. In this manner, the microservice schedule system may enable the retrieval of next and previous responder information for on-call calculations based on the schedule layer, as well as for public representational state transfer (REST) API usage that requires next and previous responder information from both the schedule and final layers.

In various embodiments, as compared to existing techniques, the data flow 500B simplifies the process of determining rotations, user entities, and/or the like that are on-call for a period of a timeline. For example, in accordance with the data flow 500, the microservice schedule system introduces a unified structure for creating the timeline, which may simplify and streamline management of on-call schedules and response to requests for on-call schedule information. The unified structure of the data flow 500B may reduce computational complexity and improve computational efficiency as compared to existing approaches shown in the data flow 500A. Further, the interval maps generated by microservice schedule system may avoid generation of recurring and empty cells observed in the arrays of existing approaches. In doing so, the microservice schedule system may reduce data redundancy and optimize storage and processing resources. As a result, the microservice architecture may demonstrate greater scalability such that the microservice schedule system is capable of handling increased data volumes without compromising performance. In some embodiments, the data flow 500B enables generation of on-call rotations using finer granularity. For example, the unified structure for generating the timeline may enable the microservice schedule system to generate rotations using 1-minute precision dates (e.g., hh:03, hh:51, and/or the like). In this manner, the microservice schedule system may generate rotations with greater flexibility and flexibility as compared to existing approaches. As a result, the microservice schedule system may generate rotations that better accommodate customized and specific scheduling requirements and user entity preferences.

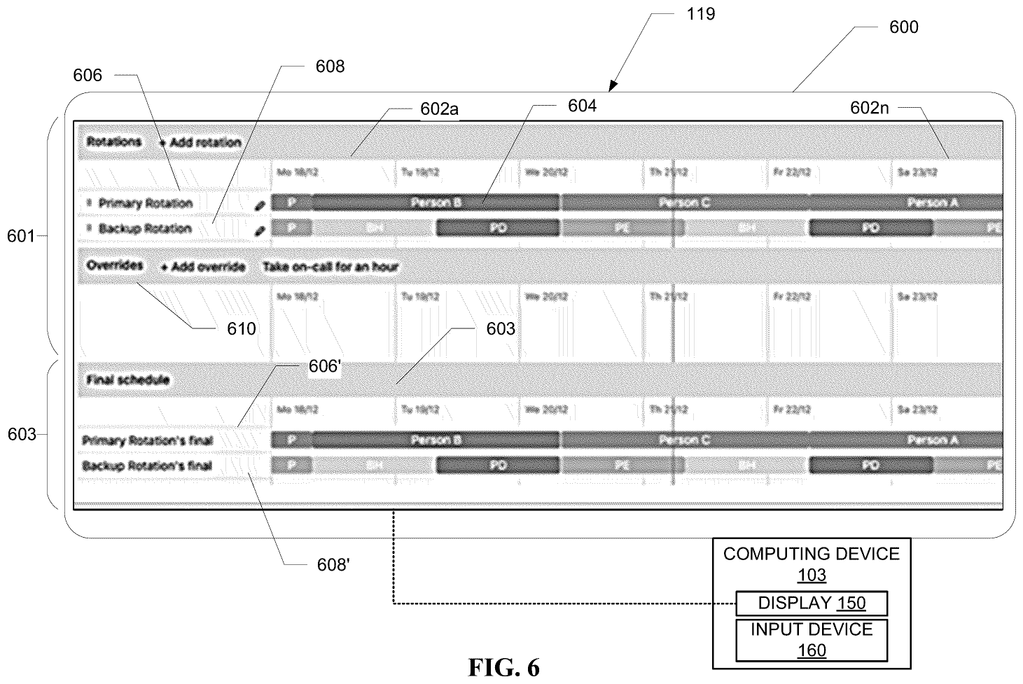

FIG. 6 shows an example task schedule interface 600 that may be generated and rendered on a display of a computing device in accordance with one or more embodiments of the present disclosure. For example, the microservice schedule system 101 may cause rendering of the task schedule interface 600 on a display 150 of a computing device 103. In various embodiments, the task schedule interface 600 includes a visualization of a timeline 119 in accordance with the task schedule. In some embodiments, the timeline 119 includes a schedule layer 601 and a final layer 603. In some embodiments, a respective layer of the timeline 119 includes a plurality of periods 602a-n. In various embodiments, a respective layer of the timeline 119 includes a plurality of task intervals 604. A respective task interval 604 may span multiple periods, portions of periods, and/or the like. A task interval 604 may be associated with a start time and an end time for performing the task. A rotation, user entity, and/or the like that is assigned to a task interval 604 may be referred to as an on-call rotation, on-call user entity, and/or the like pursuant to the task interval 604.

In some embodiments, a task interval 604 is associated with one a primary rotation 606 or a backup rotation 608. The primary rotation 606 may comprise one or more user entities that are assigned to be on-call for performing the task for a duration of a task interval 604. The backup rotation 608 may comprise one or more user entities that are assigned to replace or substitute user entities of the primary rotation 606, such as in instances where a user entity of the primary rotation 606 is unable to perform the task for all or a subset of the associated task interval 604. In various embodiments, the schedule layer 601 comprises one or more overrides 610. In some embodiments, an override 610 comprises one or more user entities that may supersede user entities of primary rotations 606 and backup rotations 608 in to perform the task for a duration of one or more task intervals otherwise assigned to the user entities of a rotation.

In various embodiments, the final layer 603 of the timeline 119 is generated based at least in part on the primary rotation 606, backup rotation 608, and overrides 610 of the schedule layer 601. In some embodiments, the final layer 603 resolves instances in which an override 610 exists for a task interval 604 which is otherwise assigned to a primary rotation 606, backup rotation 608, and/or the like. In such instances, the final layer 603 may be generated such that the override 610 takes priority in receiving assignment of the task interval (e.g., the overriding user entity receiving primary responsibility for fulfilling the task in accordance with the overridden task intervals). The final layer 603 may include an updated primary rotation 606′, which may be generated based at least in part on the primary rotation 606 of the schedule layer 601 and any overrides 610. The final layer 603 may further include an updated backup rotation 608′, which may be generated based at least in part on the backup rotation of the schedule layer 601 and any overrides 610 present.

In some embodiments, the microservice schedule system is configured to periodically generate a future portion of the timeline 119 based at least in part on a configured notification setting of the task schedule. For example, the notification setting may include a notification setting of provisioning schedule notifications on a daily, weekly, and monthly (e.g., every 4 weeks) basis. The microservice schedule system may be configured to generate the future portion of the timeline 119 based at least in part on the configured notification setting that is associated with the longest time basis. For example, in the preceding context, the microservice schedule system may generate the future portion of the timeline 119 on a monthly basis. In this manner, the microservice schedule system enables integration of various notification settings, such as “notify one week before,” “notify two weeks before,” “notify four weeks,” and/or the like.

In some embodiments, the microservice schedule system is configured to obtain data from one or more asynchronous message delivery services (e.g., Amazon Simple Notification Service (SNS), and/or the like) to detect modifications to rotations, user entities, groups of user entities (e.g., teams, organizations, and/or the like), notification hierarchies, task assignment hierarchies (e.g., primary rotations, backup rotations, overrides, and/or the like), and notification preferences of user entities. In response to obtaining a modification, the microservice schedule system may generate a new version of the future portion of the timeline 119 based at least in part on the modified rotations, user entities, notification hierarchies, task assignment hierarchies, notification preferences, and/or the like.

In various embodiments, the microservice schedule system supports exposure of on-call events to external applications via webhooks. For example, via one or more webhooks, the microservice schedule system may enable applications 106 to access or view timelines 119, task intervals 604, and rotation, backup, and override information. Additionally, or alternatively, in some embodiments, the microservice schedule system supports application integrations for viewing task schedule and rotation information, provisioning on-call event notifications, and/or the like. For example, the microservice schedule system may provision on-call event information (e.g., timelines 119, task intervals 604, rotation information, and/or the like) to a messaging application to cause rendering of the information and/or generation of event notifications within the application.

FIG. 7 is a flowchart diagram of an example process 700 for conditionally writing a rotation version to a rotation table in accordance with at least some embodiments of the present disclosure. The process 700 may be performed by various embodiments of the microservice schedule system 101 shown in FIG. 1 and described herein. For example, the process 700 may be performed by an apparatus 200 that embodies functionality of the microservice schedule system 101 described herein. In some embodiments, via various operations of the process 700, the microservice schedule system 101 may reduce data volume at and I/O requests to the rotation table and storage environment comprising the rotation table. In this manner, as compared to existing approaches, the microservice schedule system 101 may increase scalability of the microservice architecture such that additional task scheduling and notification workloads may be accommodated with minimal impact to system efficiency and throughput.

At operation 703, the process 700 includes obtaining a plurality of rotation versions from a rotation table. For example, the apparatus performing the process 700 includes means, such as the processor 202, the memory 204, the input/output circuitry 206, the communication circuitry 208, the schedule processing circuitry 209, the notification circuitry 211, or the like, for obtaining a plurality of rotation versions 118 from a rotation table 117. In some embodiments, the obtained rotation versions 118 include a current rotation version and one or more historical rotations. A respective rotation version 118 may include a listing one or more user entities assigned to perform the task pursuant to one or more task intervals of the task schedule. For example, the rotation version 118 may include one or more task intervals that represent discrete periods of the task schedule. The rotation version 118 may further include associations between one or more user entities and the task intervals such that the rotation version 118 defines a plurality of shifts for performing the task during the discrete periods of the task schedule. In some embodiments, the rotation version 118 includes overrides, backups, and/or the like comprising alternative user entities that may supplement a primary user entity of the rotation (e.g., in cases of unavailability or assertion of privilege by an overriding user entity). In some embodiments, the rotation version 118 includes a notification hierarchy that defines an escalation by which subsets of user entities associated with the rotation version 118 may be provided with on-call event notifications, and/or the like. For example, a notification hierarchy may define a sequence, ranking, and/or the like by which user entities are notified of on-call events, changes, and/or the like.

In some embodiments, operation 703 is performed in response to the obtaining of a rotation modification at operation 706. For example, in response to detecting a modification to a rotation, the apparatus performing the process 700 may obtain a plurality of rotation versions 118 from the rotation table 117, including a latest version of the rotation.

At operation 706, the process 700 includes determining whether a modification was made to the task schedule, or rotations associated therewith. For example, the apparatus performing the process 700 includes means, such as the processor 202, the memory 204, the input/output circuitry 206, the communication circuitry 208, the schedule processing circuitry 209, the notification circuitry 211, or the like, for determining whether any modifications have been performed on the rotation. In response to determining that the rotation has been modified, the process 700 may proceed to operation 712. In some embodiments, the process 700 includes, in response to detecting the modification to the rotation, enabling write access pursuant to the rotation table 117 such that the apparatus performing the process 700 may write the updated rotation version 118 to the rotation table 117. In various embodiments, the apparatus performing the process 700 is configured to abstain from writing rotation versions 118 to the rotation table 117 outside of instances in which a modification to the rotation is detected. For example, the process 700 may include repeating operations 706 until a modification to the rotation is detected, such as addition or removal of user entities, changes to task intervals, changes to user contact information, and/or the like.

In some embodiments, the apparatus performing the process 700 is configured to detect for modifications via one or more asynchronous message delivery services. For example, the apparatus may comprise one or more modules configured to subscribe to topics of the Amazon Simple Notification Service (SNS) to detect and obtain changes to a rotation. In some embodiments, the apparatus performing the process 700 is configured to obtain modifications to the rotation by from one or more applications 106 via respective APIs configured to expose application activity to the apparatus. In some embodiments, the modification to the rotation includes an adjustment of start times and/or end times for one or more task intervals with which the rotation is associated. In some embodiments, the modification includes generation or deletion of a rotation for one or more task intervals of the task schedule. For example, the modification may include creation of a new rotation or reassignment of a rotation from a first task interval to a second task interval of a task schedule. In some embodiments, the modification to the rotation includes an addition or removal of one or more user entities to or from the rotation. In some embodiments, the modification to the rotation includes a modification to overrides or backups for respective user entities of the rotation.

At operation 709, the process 700 includes updating the latest version of the rotation based at least in part on the modification to the task schedule, the rotation, and/or the like. For example, the apparatus performing the process 700 includes means, such as the processor 202, the memory 204, the input/output circuitry 206, the communication circuitry 208, the schedule processing circuitry 209, the notification circuitry 211, or the like, for updating the latest rotation version 118 based at least in part on the modification to the task schedule. At operation 712, the process 700 includes writing the updated rotation version to the rotation table. For example, the apparatus performing the process 700 includes means, such as the processor 202, the memory 204, the input/output circuitry 206, the communication circuitry 208, the schedule processing circuitry 209, the notification circuitry 211, or the like, for writing the updated rotation version 118 to the rotation table 117. In various embodiments, the updated rotation version 118 is written as a new entry to the rotation table 117 such that existing entries (e.g., historical rotation versions 118) are preserved within the table. In doing so, the rotation tables of microservice architecture may better enable debugging and historical timeline correction operations as compared to alternative approaches in which historical rotation versions may be overwritten.

At operation 715, the process 700 optionally includes provisioning one or more on-call event notifications. For example, the apparatus performing the process 700 includes means, such as the processor 202, the memory 204, the input/output circuitry 206, the communication circuitry 208, the schedule processing circuitry 209, the notification circuitry 211, or the like, for generating an on-call event notification in response to writing the updated rotation version 118 to the rotation table 117. In such contexts, the on-call event notification may be generated based at least in part on the updated rotation version 118, an updated timeline for the task schedule, and/or the like. In some embodiments, the rotation includes a plurality of a plurality of user entities assigned to perform the task in accordance with the task schedule and a notification hierarchy for provisioning notifications to the plurality of user entities. In various embodiments, the apparatus provisions respective on call-event notifications to one or more subsets of the user entities based at least in part in a sequence defined by the notification hierarchy. In some embodiments, operation 718 may include performing one or more embodiments of a process 800 managing and provisioning on-call event notifications, as shown in FIG. 8 and described herein. For example, in response to the modification of the rotation, the apparatus may perform the process 800 to determine and discard on-call event notifications that were generated in accordance with historical rotation versions 118, which may be made obsolete or invalid by the rotation modification.

At operation 718, the process 700 optionally includes generating a new version of one or more portions of a timeline for the task schedule. For example, the apparatus performing the process 700 includes means, such as the processor 202, the memory 204, the input/output circuitry 206, the communication circuitry 208, the schedule processing circuitry 209, the notification circuitry 211, or the like, for generating a new version of one or more portions of a timeline 119 based at least in part on the modification to the rotation, user data 131 associated with the rotation, and/or the like. In some embodiments, the timeline 119 includes a first “historical” portion and a second “future” portion. In some embodiments, the apparatus performing the process 700 is configured to generate the first portion of the timeline 119 based at least in part on one or more historical rotation versions 118 from the rotation table 117. In some embodiments, the apparatus performing the process 700 is configured to generate the second portion of the timeline 119 based at least in part on the updated rotation version 118 (e.g., as obtained at operation 712). In some embodiments, the timeline includes a first “schedule” layer and a second “final” layer. The apparatus performing the process 700 may generate the schedule layer based at least in part on respective on-call times for a plurality of user entities assigned to the rotation version 118. The apparatus performing the process 700 may generate the final layer based at least in part on the first layer and a respective on-call time associated with a user entity assigned to override or backup one or more of the plurality of user entities assigned to the rotation version 118.

At operation 721, the process 700 optionally includes causing rendering of the updated timeline on a display of one or more computing devices. For example, the apparatus performing the process 700 includes means, such as the processor 202, the memory 204, the input/output circuitry 206, the communication circuitry 208, the schedule processing circuitry 209, the notification circuitry 211, or the like, for causing rendering of the timeline 119 on a display 150 of a computing device 103. In some embodiments, the apparatus performing the process 700 causes rendering of a task schedule interface comprising the updated timeline 119. For example, the apparatus may cause rendering of a task schedule interface 600 (FIG. 6) comprising the updated timeline 119.

At operation 724, the process 700 optionally includes receiving a request to report one or more on-call user entities in accordance with the task schedule. For example, the apparatus performing the process 700 includes means, such as the processor 202, the memory 204, the input/output circuitry 206, the communication circuitry 208, the schedule processing circuitry 209, the notification circuitry 211, or the like, for receiving from a computing device 103 a request to report one or more user entities that are on-call for performing the task pursuant to one of a plurality of task intervals of the task schedule, the request indicating said input task interval. In some embodiments, the request is received from the computing device 103 via an API 142.

At operation 727, the process 700 optionally includes generating interval maps based at least in part on the timeline of the task schedule. For example, the apparatus performing the process 700 includes means, such as the processor 202, the memory 204, the input/output circuitry 206, the communication circuitry 208, the schedule processing circuitry 209, the notification circuitry 211, or the like, for generating a first interval map and a second interval map based at least in part on the timeline 119. In some embodiments, the apparatus performing the process 700 generates a first interval map based at least in part on the schedule layer of the timeline 119 and a second interval map based at least in part on the final layer of the timeline 119.

At operation 730, the process 700 optionally includes determining one or more on-call user entities pursuant to one or more task intervals of the task schedule. For example, the apparatus performing the process 700 includes means, such as the processor 202, the memory 204, the input/output circuitry 206, the communication circuitry 208, the schedule processing circuitry 209, the notification circuitry 211, or the like, for determining on-call user entities for a current task interval, a historical task interval, and a future task interval. In some embodiments, the apparatus performing the process 700 determines, based at least in part on the second interval map, one or more user entities that are on-call for performing the task pursuant to the input task interval. In some embodiments, the apparatus performing the process 700 determines, based at least in part on the first interval map and the second interval map, i) at least one user entity that that was on-call for a historical task interval preceding the input task interval, and ii) at least one user entity that is on-call for a future task interval proceeding the input task interval.

At operation 733, the process 700 optionally includes provisioning a report to the computing device from which the request of operation 730 was received. For example, the apparatus performing the process 700 includes means, such as the processor 202, the memory 204, the input/output circuitry 206, the communication circuitry 208, the schedule processing circuitry 209, the notification circuitry 211, or the like, for provisioning a report to the computing device 103 via an API 142. In various embodiments, the report includes the one or more on-call entities for the input task interval. In some embodiments, the report includes the one or more user entities that were on-call for a historical task interval preceding the input task interval. In some embodiments, the report includes the at least one user entity that is on-call for the future task interval proceeding the input task interval.

FIG. 8 is a flowchart diagram of an example process 800 for managing and provisioning on-call event notifications in accordance with at least some embodiments of the present disclosure. The process 800 may be performed by various embodiments of the microservice schedule system 101 shown in FIG. 1 and described herein. For example, the process 800 may be performed by an apparatus 200 that embodies functionality of the microservice schedule system 101 described herein. In some embodiments, via various operations of the process 800, the microservice schedule system 101 may filter on-call event notifications to remove obsolete data and, in doing, so increase efficiency and scalability of coordinating notification delivery at peak intervals of rotation activity for task schedules.

At operation 803, the process 800 includes obtaining one or more modifications to a task schedule. For example, the apparatus performing the process 800 includes means, such as the processor 202, the memory 204, the input/output circuitry 206, the communication circuitry 208, the schedule processing circuitry 209, the notification circuitry 211, or the like, for detecting a modification to a task schedule, such as by obtaining and processing data from one or more communication channels of an asynchronous message delivery service. For example, the apparatus may be configured to detect and process messages provisioned via the asynchronous message delivery service. In such contexts, the messages may include user inputs for adjusting rotations, modifying user contact information, configuring task intervals, and/or the like. In various embodiments, the task schedule is associated with a plurality of stored on-call event notifications.

At operation 806, the process 800 includes determining a subset of the plurality of on-call event notifications that is obsolete based at least in part on one or more modifications to the task schedule. For example, the apparatus performing the process 800 includes means, such as the processor 202, the memory 204, the input/output circuitry 206, the communication circuitry 208, the schedule processing circuitry 209, the notification circuitry 211, or the like, for determining a subset of the plurality of on-call event notifications that is obsolete based at least in part on one or more modifications to the task schedule. The modification may include updates to a rotation (e.g., addition or removal of a user entity), modifications to task intervals, changes to user notification preferences, changes to user contact data, addition or removal of a rotation, changes to overrides or backups, and/or the like.

At operation 809, the process 800 includes removing the one more on-call event notifications determined to be obsolete. For example, the apparatus performing the process 800 includes means, such as the processor 202, the memory 204, the input/output circuitry 206, the communication circuitry 208, the schedule processing circuitry 209, the notification circuitry 211, or the like, for removing the obsolete subset of the plurality of on-call event notifications from the task schedule In doing so, the apparatus may prevent subsequent provision of the obsolete notifications.

In some embodiments, the process 800 optionally includes generating one or more additional on-call event notifications based at least in part on the one or more modifications to the task schedule. For example, the apparatus performing the process 800 includes means, such as the processor 202, the memory 204, the input/output circuitry 206, the communication circuitry 208, the schedule processing circuitry 209, the notification circuitry 211, or the like, for generating one or more additional on-call event notifications based at least in part on the one or more modifications to the task schedule. For example, a rotation version 118 may be updated to include an additional user entity, and the apparatus may generate an additional on-call notification that may be provisioned to the additional user entity.

In some embodiments, the process 800 optionally includes resetting a meter associated with triggering a period update to the plurality of on-call event notifications. For example, the apparatus performing the process 800 includes means, such as the processor 202, the memory 204, the input/output circuitry 206, the communication circuitry 208, the schedule processing circuitry 209, the notification circuitry 211, or the like, for resetting a meter associated with triggering a period update to the plurality of on-call event notifications. In doing so, the apparatus may prevent performance of redundant processes for reviewing the on-call event notifications, thereby conserving computing resources. In some embodiments, the apparatus is configured to partition processes for on-call event calculation and notification generation such that bulk processing may be divided into a plurality of threads. In this manner, the apparatus may implement a load balancer that reduces throttling events. For example, with the partitioning, the apparatus may enable horizontal scaling for adapting to changing workloads.

At operation 812, the process 800 optionally includes obtaining one or more user inputs comprising one or more time factors for configuring the time at which on-call event notifications are triggered in advance of the associated task interval. For example, the apparatus performing the process 800 includes means, such as the processor 202, the memory 204, the input/output circuitry 206, the communication circuitry 208, the schedule processing circuitry 209, the notification circuitry 211, or the like, for receiving, from a computing device 103, application 106, and/or the like, a time factor pursuant to a user entity and rotation to which the user entity is assigned. In some embodiments, the apparatus obtains the time factor in response to generation of a new on-call event, such as generation of a new rotation or addition of a new user entity to a rotation.

In some embodiments, the time factor defines a custom period in advance of which an on-call notification may be provisioned to the user entity (e.g., by way of an application 106, computing device 103, and/or the like). For example, the time factor may configure advance on-call notification of 2 weeks, 3 weeks, 36 hours, 1 month, or other user-specified value. In this manner, the provision of on-call notifications may be customized to accommodate user preferences, user schedules, organizational policies, and/or the like. For example, existing approaches may be limited to triggering on-call event notification in a 1-day window, whereas the present techniques and architecture enable provision of on-call event notifications on a more flexible and arbitrary basis.

At operation 815, the process 800 optionally includes generating one or more on-call event notifications based at least in part on respective time factors obtained at operation 812. For example, the apparatus performing the process 800 includes means, such as the processor 202, the memory 204, the input/output circuitry 206, the communication circuitry 208, the schedule processing circuitry 209, the notification circuitry 211, or the like, for generating an on-call event notification based at least in part on the time factor for advance on-call notification of 2 weeks, 3 weeks, 36 hours, 1 month, or other user-specified value. In various embodiments, the new on-call event notification. In various embodiments, the new on-call event modification may be added to a remaining subset of the plurality of on-call event notifications that is obtained in accordance with operation 809.

At operation 818, the process 800 optionally includes provisioning, to one or one computing devices, a remaining subset of the plurality of on-call event notifications. For example, the apparatus performing the process 800 includes means, such as the processor 202, the memory 204, the input/output circuitry 206, the communication circuitry 208, the schedule processing circuitry 209, the notification circuitry 211, or the like, for provisioning, to a respective computing device 103 of one or more user entities, a remaining subset of the plurality of on-call event notifications in accordance with task intervals defined by the task schedule.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a computing device (e.g., for purposes of displaying information/data to and receiving user input from a user interacting with the computing device). Information/data generated at the computing device (e.g., a result of the user interaction) can be received from the computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method, comprising:
obtaining from a rotation table a plurality of versions of a rotation for performing a task in accordance with a task schedule, wherein:
the plurality of versions comprises at least one historical version of the rotation and a current version of the rotation;
in response to detecting at least one modification to the rotation, updating the current version of the rotation to generate an updated version of the rotation;
enabling write access for the rotation table in response to the updated version of the rotation;
writing the updated version of the rotation to the rotation table, the updated version of the rotation being written as an additional entry to the plurality of versions of the rotation;
generating a timeline for the task schedule based at least in part on the at least one historical version of the rotation and updated version of the rotation; and
causing rendering of a graphical user interface (GUI) on a display of at least one computing device, the GUI comprising the timeline.

2. The computer-implemented method of claim 1, further comprising:
generating a first portion of the timeline based at least in part on the at least one historical version of the rotation; and
generating a second portion of the timeline based at least in part on the updated version of the rotation.

3. The computer-implemented method of claim 2, wherein:
the timeline comprises a first layer and a second layer;
the first layer is generated based at least in part on respective on-call times for a plurality of user entities associated with the rotation; and
the second layer is generated based at least in part on the first layer and a respective on-call time associated with a user entity assigned to override or backup at least one of the plurality of user entities associated with the rotation.

4. The computer-implemented method of claim 3, further comprising:
receiving, from a computing device and via an application programming interface (API), a request to report at least one user entity that is on-call for performing the task pursuant to an input task interval, the input task interval indicating one of a plurality of task intervals of the task schedule;
generating a first interval map based at least in part on the first layer of the timeline and a second interval map based at least in part on the second layer of the timeline;
determining, based at least in part on the second interval map, the at least one user entity that is on-call for performing the task pursuant to the input task interval;
determining, based at least in part on the first interval map and the second interval map, i) at least one user entity that that was on-call for a historical task interval preceding the input task interval, and ii) at least one user entity that is on-call for a future task interval proceeding the input task interval; and
provisioning, to the computing device and via the API, a report indicating the at least one user entity that is on-call for performing the task pursuant to the input task interval, the at least one user entity that that was on-call for the historical task interval preceding the input task interval, and the at least one user entity that is on-call for the future task interval proceeding the input task interval.

5. The computer-implemented method of claim 2, wherein:
the rotation comprises a listing of a plurality of user entities assigned to perform the task in accordance with the task schedule; and
the method further comprises:
causing rendering of the GUI on a display of respective computing devices of at least a subset of the plurality of user entities.

6. The computer-implemented method of claim 5, further comprising:
receiving the at least one modification to the rotation from at least one of the respective computing devices via an application programming interface (API).

7. The computer-implemented method of claim 2, further comprising:
generating a record of modifications to the rotation based at least in part on the updated version of the rotation, the at least one historical version of the rotation, and the timeline; and
provisioning the record of modifications to at least one computing device.

8. The computer-implemented method of claim 1, wherein:
the rotation comprises a listing of at least one user entity assigned to perform the task in accordance with the task schedule; and
the at least one modification to the rotation comprises at least one of i) a removal of a user entity from the listing, or ii) an addition of a user entity to the listing.

9. The computer-implemented method of claim 8, wherein:
the at least one user entity comprises a first user entity assigned to perform the task and at least one additional user entity associated with supplementing the first user entity in performance of the task.

10. The computer-implemented method of claim 1, wherein:
the rotation comprises a task interval associated with performance of the task pursuant to the task schedule; and
the at least one modification to the rotation comprises an adjustment to the task interval.

11. The computer-implemented method of claim 1, wherein:
the rotation comprises:
a plurality of user entities assigned to perform the task in accordance with the task schedule; and
a notification hierarchy for provisioning notifications to the plurality of user entities; and
the method further comprises:
in response to writing the updated version of the rotation to the rotation table, generating an on-call event notification based at least in part on the updated version of the rotation; and
provisioning the on-call event notification to a respective computing device of at least a subset of the plurality of user entities based at least in part on the notification hierarchy.

12. An apparatus, the apparatus comprising at least one processor and at least one non-transitory memory comprising program code, wherein the at least one non-transitory memory and the program code are configured to, with the at least one processor, cause the apparatus to:
obtain from a rotation table a plurality of versions of a rotation for performing a task in accordance with a task schedule, wherein:
the plurality of versions comprises at least one historical version of the rotation and a current version of the rotation;
in response to a detection of at least one modification to the rotation, update the current version of the rotation to generate an updated version of the rotation;
enable write access for the rotation table in response to the updated version of the rotation; and
write the updated version of the rotation to the rotation table, the updated version of the rotation being written as an additional entry to the plurality of versions of the rotation.

13. The apparatus of claim 12, wherein:
the at least one non-transitory memory and the program code are further configured to, with the at least one processor, cause the apparatus to:
generate a first portion of a timeline for the task schedule based at least in part on the at least one historical version of the rotation; and
generate a second portion of the timeline based at least in part on the updated version of the rotation.

14. The apparatus of claim 13, wherein:
the timeline comprises a first layer and a second layer;
the first layer is generated based at least in part on respective on-call times for a plurality of user entities associated with the rotation; and
the second layer is generated based at least in part on the first layer and a respective on-call time associated with a user entity assigned to override or backup at least one of the plurality of user entities associated with the rotation.

15. The apparatus of claim 14, wherein:
the at least one non-transitory memory and the program code are further configured to, with the at least one processor, cause the apparatus to:
receive, from a computing device and via an application programming interface (API), a request to report at least one user entity that is on-call for performing the task pursuant to an input task interval, the input task interval indicating one of a plurality of task intervals of the task schedule;
generate a first interval map based at least in part on the first layer of the timeline and a second interval map based at least in part on the second layer of the timeline;
determine, based at least in part on the second interval map, the at least one user entity that is on-call for performing the task pursuant to the input task interval;
determine, based at least in part on the first interval map and the second interval map, i) at least one user entity that that was on-call for a historical task interval preceding the input task interval, and ii) at least one user entity that is on-call for a future task interval proceeding the input task interval; and
provision, to the computing device and via the API, a report indicating the at least one user entity that is on-call for performing the task pursuant to the input task interval, the at least one user entity that that was on-call for the historical task interval preceding the input task interval, and the at least one user entity that is on-call for the future task interval proceeding the input task interval.

16. The apparatus of claim 14, wherein:
the rotation comprises a listing of at least one user entity assigned to perform the task in accordance with the task schedule; and
the at least one non-transitory memory and the program code are further configured to, with the at least one processor, cause the apparatus to:
cause rendering of the timeline on a display of a respective computing device of the at least one user entity.

17. The apparatus of claim 16, wherein:
the at least one non-transitory memory and the program code are further configured to, with the at least one processor, cause the apparatus to:
receive the at least one modification to the rotation from the computing device via an application programming interface (API).

18. The apparatus of claim 13, wherein:
the at least one non-transitory memory and the program code are further configured to, with the at least one processor, cause the apparatus to:
generate a record of modifications to the rotation based at least in part on the updated version of the rotation, the at least one historical version of the rotation, and the timeline; and
provision the record of modifications to at least one computing device.

19. The apparatus of claim 12, wherein:
the rotation comprises a listing of at least one user entity assigned to perform the task in accordance with the task schedule; and
the at least one modification to the rotation comprises at least one of i) a removal of a user entity from the listing, or ii) an addition of a user entity to the listing.

20. A computer program product, the computer program product comprising at least one non-transitory computer-readable storage medium having computer-readable program code portions stored therein, the computer-readable program code portions configured to:
obtain from a rotation table a plurality of versions of a rotation for performing a task in accordance with a task schedule, wherein:
the plurality of versions comprises at least one historical version of the rotation and a current version of the rotation;
in response to a detection of at least one modification to the rotation, update the current version of the rotation to generate an updated version of the rotation;
enable write access for the rotation table in response to the updated version of the rotation; and
write the updated version of the rotation to the rotation table, the updated version of the rotation being written as an additional entry to the plurality of versions of the rotation.
